(19) United States
(12) Patent Application Publication
(10) Pub. No.: US 2026/0057669 A1
(43) Pub. Date: Feb. 26, 2026

(54) COMPUTER SYSTEMS, METHODS, AND NON-TRANSITORY COMPUTER-READABLE STORAGE DEVICES FOR MANAGING HOMEOWNER RENEWABLE ENERGY INCENTIVES

(71) Applicant: ROYAL BANK OF CANADA, Toronto (CA)

(72) Inventors: Nickolas ZAMACHNOI, Ottawa (CA); Melanie WANG, Toronto (CA); Michael MARIANO, Toronto (CA); Aakash VAITHYANATHAN, Toronto (CA); Lucan MCRANDALL, Toronto (CA); Graham A. WATT, Toronto (CA); Altaf Hussain SHAIK, Oshawa (CA); Amir MEMARTOLUIE, Oakville (CA); Krishna RUTHNUM, Toronto (CA); Shambhavi TIWARI, Toronto (CA); Jinoj TITUS, Toronto (CA); He XU, Toronto (CA)

(21) Appl. No.: 19/302,970

(22) Filed: Aug. 18, 2025

Related U.S. Application Data
(60) Provisional application No. 63/685,640, filed on Aug. 21, 2024.

(51) Int. Cl. G06V 20/10; G06V 10/25; G06V 10/762; G06V 10/82; G06V 30/148; G06V 30/19; G06V 30/416; H02S 20/23; H02S 50/10

(52) U.S. Cl. CPC G06V 20/176; G06V 10/25; G06V 10/762; G06V 10/82; G06V 30/153; G06V 30/19107; G06V 30/416; H02S 20/23; H02S 50/10

(57) ABSTRACT

A computerized method for managing solar systems, the method has the steps of: estimating solar power generation of the housing structure based on the plan-view image of the housing structure, and validating a document related to the solar power generation of the housing structure based on an image of the document and non-text features of the image of the document.

### CROSS-REFERENCE TO RELATED APPLICATIONS

This application claims priority to U.S. Provisional Application No. 63/685,640, entitled “COMPUTER SYSTEMS, METHODS, AND NON-TRANSITORY COMPUTER-READABLE STORAGE DEVICES FOR MANAGING HOMEOWNER RENEWABLE ENERGY INCENTIVES”, filed Aug. 21, 2024, which is hereby incorporated by reference in its entirety.

### TECHNICAL FIELD

The present disclosure relates generally to computer systems, methods, and non-transitory computer-readable storage devices, and in particular to computer systems, methods, and non-transitory computer-readable storage devices for managing homeowner renewable energy incentives.

### BACKGROUND

Renewable energy sources have gained increasing attention in recent years as societies seek to reduce reliance on fossil fuels and mitigate environmental impacts. Solar power, in particular, has emerged as a promising option for residential energy generation. As more homeowners install solar panels on their properties, there is growing interest in mechanisms to incentivize and reward clean energy production at the individual level.

Renewable energy certificates (RECs) represent the environmental attributes of electricity generated from renewable sources. These certificates can be bought and sold separately from the actual electricity produced. For utility-scale renewable energy projects, there are established markets and systems for trading RECs. However, the process of quantifying and validating renewable energy generation from individual residential solar installations presents unique challenges.

As residential solar adoption continues to grow, there is an opportunity to develop improved computer systems and methods to facilitate homeowner participation in renewable energy incentive programs. Such systems could help maximize the economic and environmental benefits of distributed clean energy generation.

### SUMMARY

According to one aspect of this disclosure, there is provided a computerized method for managing solar systems, the method comprising estimating solar power generation of the housing structure based on the plan-view image of the housing structure; and validating a document related to the solar power generation of the housing structure based on an image of the document and non-text features of the image of the document.

In some embodiments, the computerized method further comprises determining a housing structure suitable for solar system installation based on the plan-view image of the housing structure.

In some embodiments, said determining the housing structure suitable for solar system installation comprises extracting a roof feature of the housing structure from the plan-view image of the housing structure; fitting a representation of one or more solar panels into the extracted roof feature; and determining that the housing structure is suitable for solar system installation if said fitting is successful.

In some embodiments, said determining the housing structure suitable for solar system installation further comprises estimating a number of panels required to produce annual electricity close to a potential value; and identifying available space on the extracted roof feature.

In some embodiments, said estimating the solar power generation of the housing structure comprises extracting a roof feature of the housing structure from the plan-view image of the housing structure; identifying one or more solar panels from the extracted roof feature; and estimating the solar power generation based on the number of identified solar panels and an a physical size of each solar panel.

In some embodiments, said estimating the solar power generation of the housing structure further comprises obtaining a latitude and longitude of a location of the housing structure by geocoding an address of the housing structure; obtaining at least one of wind speed, cloud information, and temperature pertaining to the location of the housing structure; and estimating the solar power generation based on the number of identified solar panels, the physical size of each solar panel and the at least one of wind speed, cloud information, and temperature pertaining to the location of the housing structure.

In some embodiments, said validating a document related to the solar power generation of the housing structure comprises validating that information extracted from the document aligns with the estimated solar power generation.

In some embodiments, said validating the document related to the solar power generation of the housing structure comprises recognizing words from the image of the document; determining a bounding box for each recognized word; generating a matrix for each bounding box, the matrix comprising edge distances between the bounding box and other bounding boxes, and each edge distance being a distance between closest edges of the bounding box and a corresponding one of the other bounding boxes; clustering the recognized words based on the edge distances and sizes of the bounding boxes; ranking the clusters based on a prompt; determining one or more most relevant clusters based on said ranking; and generating structured output for validation.

In some embodiments, the structured output is in a JSON format.

In some embodiments, the computerized method further comprises using the structured output to validate the document based on a long short-term memory (LSTM) machine-learning model.

According to one aspect of this disclosure, there is provided a system comprising one or more processors; and one or more non-transitory computer-readable storage media functionally coupled to the one or more processors; wherein the or more non-transitory computer-readable storage media comprise computer-executable instructions; and wherein the instructions, when executed, cause the one or more processors to perform the above-described method.

According to one aspect of this disclosure, there are provided one or more non-transitory computer-readable storage devices comprising computer-executable instructions, wherein the instructions, when executed, cause one or more processing units to perform the above-described method.

According to one aspect of this disclosure, there is provided a system comprising one or more processors; and one or more non-transitory computer-readable storage media functionally coupled to the one or more processors; wherein the or more non-transitory computer-readable storage media comprise computer-executable instructions; and wherein the instructions, when executed, cause the one or more processors to perform the method comprising: estimating solar power generation of a housing structure based on a plan-view image of the housing structure; and validating a document related to the solar power generation of the housing structure based on an image of the document and non-text features of the image of the document.

In some embodiments the method further comprises determining a housing structure suitable for solar system installation based on the plan-view image of the housing structure.

In some embodiments, said determining the housing structure suitable for solar system installation comprises extracting a roof feature of the housing structure from the plan-view image of the housing structure; fitting a representation of one or more solar panels into the extracted roof feature; and determining that the housing structure is suitable for solar system installation if said fitting is successful.

In some embodiments, said determining the housing structure suitable for solar system installation further comprises estimating a number of panels required to produce annual electricity close to a potential value; and identifying available space on the extracted roof feature.

In some embodiments, said estimating the solar power generation of the housing structure comprises extracting a roof feature of the housing structure from the plan-view image of the housing structure; identifying one or more solar panels from the extracted roof feature; and estimating the solar power generation based on the number of identified solar panels and a physical size of each solar panel.

In some embodiments, said estimating the solar power generation of the housing structure further comprises obtaining a latitude and longitude of a location of the housing structure by geocoding an address of the housing structure; obtaining at least one of wind speed, cloud information, and temperature pertaining to the location of the housing structure; and forecasting the solar power generation based on the number of identified solar panels, the physical size of each solar panel and the at least one of wind speed, cloud information, and temperature pertaining to the location of the housing structure.

In some embodiments, said validating a document related to the solar power generation of the housing structure comprises validating that information extracted from the document aligns with the estimated solar power generation.

In some embodiments, said validating the document related to the solar power generation of the housing structure comprises recognizing words from the image of the document; determining a bounding box for each recognized word; generating a matrix for each bounding box, the matrix comprising edge distances between the bounding box and other bounding boxes, and each edge distance being a distance between closest edges of the bounding box and a corresponding one of the other bounding boxes; clustering the recognized words based on the edge distances and sizes of the bounding boxes; ranking the clusters based on a prompt; determining one or more most relevant clusters based on said ranking; and generating structured output for validation.

In some embodiments, the system further comprises using the structured output to validate the document based on a long short-term memory (LSTM) machine-learning model.

According to one aspect of this disclosure, there are provided one or more non-transitory computer-readable storage media comprising computer-executable instructions, wherein the instructions, when executed, cause one or more processors to perform the method comprising estimating solar power generation of a housing structure based on a plan-view image of the housing structure; and validating a document related to the solar power generation of the housing structure based on an image of the document and non-text features of the image of the document.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a computer network system according to some embodiments of this disclosure;

FIG. 2 is a block diagram of a server of the computer network system shown in FIG. 1;

FIG. 3A is a schematic diagram showing a functional architecture of the computer network system shown in FIG. 1, according to some embodiments of this disclosure;

FIG. 3B is a schematic diagram showing details of the frontend layer and the user group and credential management module shown in FIG. 1, according to some embodiments of this disclosure;

FIG. 3C is a schematic diagram showing details of the backend layer, the artificial intelligence (AI)/machine learning (ML) models, and the data layer shown in FIG. 1, according to some embodiments of this disclosure;

FIG. 4 is a flowchart showing the steps of an image-based solar energy estimation method performed by the computer network system shown in FIG. 1, according to some embodiments of this disclosure;

FIGS. 5A to 5C show an example of the image-based solar energy estimation method shown in FIG. 4, wherein

FIG. 5A shows an example of a satellite image of a house,

FIG. 5B shows an example of a predicted image mask generated by the image-based solar energy estimation method shown in FIG. 4 using an AI model and after noise cleaning, and

FIG. 5C shows an example of a “true” image mask obtained manually using image processing but without using any AI model;

FIG. 6 is a flowchart showing the steps of an image-based client targeting method performed by the computer network system shown in FIG. 1, according to some embodiments of this disclosure;

FIGS. 7A to 7D shows an example of the image-based client targeting method shown in FIG. 6, wherein

FIG. 7A shows an example of a satellite image of a house,

FIG. 7B shows a transformed image of the satellite image shown in FIG. 7A,

FIG. 7C shows an example of an image mask generated by the image-based client targeting method shown in FIG. 6, and

FIG. 7D shows an example of a cleaned image mask generated by the image-based client targeting method shown in FIG. 6;

FIGS. 8A and 8B show an example of a roof (FIG. 8A) and possible placement of a solar panel thereon (FIG. 8B);

FIGS. 9A and 9B show another example of a roof (FIG. 9A) and possible placement of a solar panel thereon (FIG. 9B);

FIG. 10A and FIG. 10B are a flowchart showing a user registration method performed by the computer network system shown in FIG. 1, according to some embodiments of this disclosure;

FIG. 11A and FIG. 11B are a flowchart showing a user document content extraction method performed by the computer network system shown in FIG. 1, according to some embodiments of this disclosure;

FIG. 12A shows an example of a document image;

FIG. 12B shows the recognized words and their corresponding bounding boxes, using the user document content extraction method shown in FIG. 11A and FIG. 11B;

FIG. 12C shows the bounding boxes without the recognized words for better illustration of the bounding boxes;

FIG. 13A and FIG. 13B are a flowchart showing a generation validation method performed by the computer network system shown in FIG. 1, according to some embodiments of this disclosure;

FIG. 14A and FIG. 14B are a flowchart showing an attestation method performed by the computer network system shown in FIG. 1, according to some embodiments of this disclosure;

FIG. 15A and FIG. 15B show the user flow diagrams of the computer network system shown in FIG. 1, according to some embodiments of this disclosure;

FIG. 16A is an example landing interface for a user of the system, according to some embodiments of this disclosure;

FIG. 16B is an example interface for mortgage house selection, according to some embodiments of this disclosure;

FIG. 16C is an example registration interfce for the user of the system, according to some embodiments of this disclosure;

FIG. 16D is an example system overview interface, according to some embodiments of this disclosure;

FIG. 16E is an example of a solar installation details interface after analysis, according to some embodiments of this disclosure;

FIG. 16F is an example showing approximate annual savings calculations, according to some embodiments of this disclosure;

FIG. 16G is an example user interface for registration and attestation, according to some embodiments of this disclosure;

FIG. 16H is an example attestation interface, according to some embodiments of this disclosure;

FIG. 16I shows an example attestation document, according to some embodiments of this disclosure;

FIG. 16J shows an example of a solar power generation attestation after analysis, according to some embodiments of this disclosure;

FIG. 17 is a flowchart of a method for managing solar systems, according to some embodiments of this disclosure;

FIG. 18 is a flowchart of a process of determining housing structure suitability for solar system installation, according to some embodiments of this disclosure;

FIG. 19 is a flowchart of a process of estimating solar power generation, according to some embodiments of this disclosure; and

FIG. 20 is a flowchart of a process of validating a document related to solar power generation, according to some embodiments of this disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Embodiments disclosed herein relate to a computer network system and related software applications such as web applications for supporting and managing a homeowner renewable energy incentive program.

Embodiments disclosed herein provide a computerized method and system for managing solar systems. The method may include estimating solar power generation of a housing structure based on a plan-view image of the housing structure. This estimation process may involve extracting roof features from the plan-view image, identifying solar panels within the extracted roof features, and calculating potential solar power generation based on the number and size of identified panels. The method may also include validating documents related to solar power generation. This validation process may utilize information extracted from the document to validate if the information aligns with the estimated solar power generation.

In some implementations, the method may determine the suitability of a housing structure for solar system installation. This determination may be made by analyzing the plan-view image of the structure, extracting roof features, and attempting to fit representations of solar panels onto the extracted roof features. The method may also incorporate geocoded location data and local weather information to refine solar generation estimates.

In some implementations, document validation may involve advanced text recognition techniques, including word clustering based on spatial relationships within the document image, and the use of machine learning models to assess the validity of submitted generation data.

Renewable energy certificates (RECs) represent the environmental attributes of electricity generated from renewable sources. These certificates can be bought and sold separately from the actual electricity produced. For utility-scale renewable energy projects, there are established markets and systems for trading RECs. However, the process of quantifying and validating renewable energy generation from individual residential solar installations presents unique challenges.

Financial institutions and other organizations seeking to offset their carbon emissions through REC purchases face significant data processing and validation challenges when attempting to source certificates from numerous small-scale residential generators. The sheer volume of distributed data from individual homeowners, coupled with the need for rigorous verification, creates computational bottlenecks and scalability issues in traditional systems. Streamlined computer-implemented processes for efficiently connecting REC buyers with homeowner sellers, while ensuring proper automated validation and secure digital documentation, could help overcome these technical hurdles. Such improvements in data handling, verification algorithms, and transaction processing capabilities could enhance the computational efficiency and scalability of computer systems, thereby expanding participation and optimizing the allocation of computational resources in these markets.

Residential solar systems vary widely in size, configuration, and energy output. Accurately measuring and verifying the amount of clean energy produced by each household system over time may require robust data collection and validation methods. Additionally, aggregating small-scale residential generation into meaningful quantities for REC markets necessitates efficient systems for processing information from many distributed sources.

In some embodiments, the computer network system allows clients to sell the rights to their solar generation offsets in the form of RECs.

In some embodiments, the computer network system provides suitable functionality for identifying homes with sufficient solar radiation and suitable for solar panel installation, so as to promote various solar incentives to the owners thereof.

In some embodiments, the computer network system provides suitable functionality for automated validation of installation and generation documents at scale to significantly reduce need for manual review, with high certainty and accuracy.

In some embodiments, the computer network system provides a user dashboard to view financial and emissions savings.

In some embodiments, the computer network system provides an administration dashboard to view and download client yearly generation, and manual review.

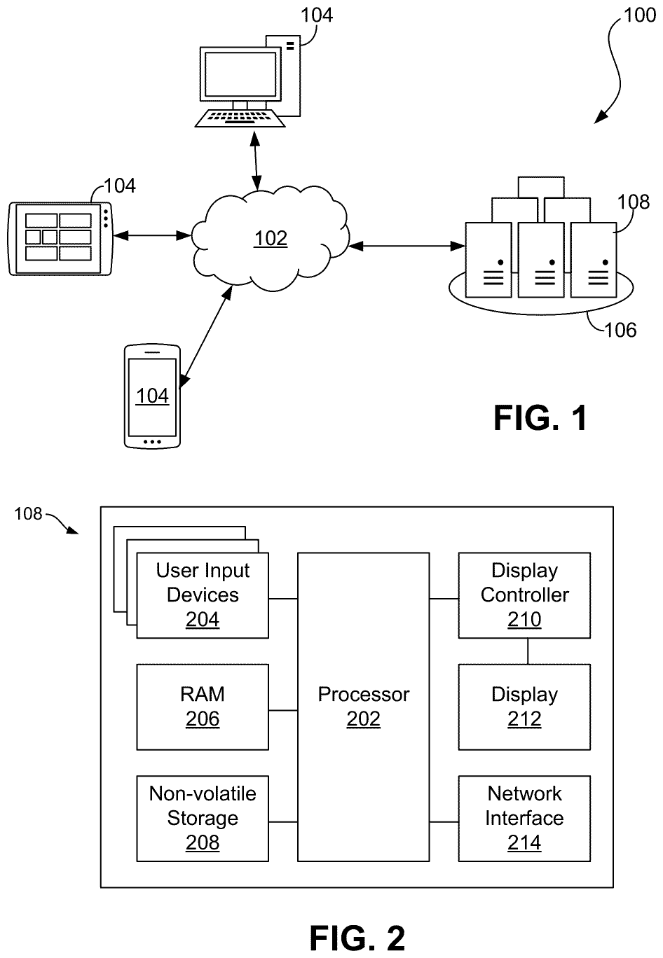

Referring now to FIG. 1, there is shown a computer network system 100 that comprises an example embodiment of a computerized service system. Herein, a “user” refers to a user of the computer network system 100.

As shown in FIG. 1, the computer network system 100 comprises a network 102 such as a local area network (LAN), a metropolitan area network (MAN), a wide area network 102 (WAN; for example, the Internet) and/or the like, to which various user devices 104, and data center 106 are communicatively coupled via suitable wired and/or wireless networking connections, such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 4G, 5G, 6G, and/or other mobile communication networks, and/or the like. In some embodiments, parallel ports, serial ports, USB connections, optical connections, or the like may also be used for connecting other computing devices or networks although they are usually considered as input/output interfaces for connecting input/output devices.

The data center 106 comprises one or more servers 108 networked together to collectively perform various computing functions. For example, in the context of a financial institution such as a bank, the data center 106 may host online banking services that permit users to log in to servers 108 thereof using user accounts that give them access to various computer-implemented services, such as management and related services and/or online fund transfers.

Referring now to FIG. 2, there is depicted an example embodiment of one of the servers 108 of the data center 106. The server 108 comprises one or more processors 202 that control the server's overall operation. The one or more processors 202 are communicatively coupled to and control several subsystems. These subsystems comprise one or more user input devices 204, which may comprise, for example, any one or more of a keyboard, mouse, touch screen, voice control, and/or the like; one or more non-transitory computer-readable storage devices or media 206 such as random access memory (“RAM”), which store computer-executable instructions or program code for execution at runtime by the processor 202; non-transitory, non-volatile, computer-readable storage devices or media 208, which store the computer-executable instructions or program code executed by the RAM 206 at runtime; a display controller 210, which is communicatively coupled to and controls a display 212; and a network interface 214, which facilitates network communications with the wide area network 102 and the other servers 108 in the data center 106. The non-volatile storage 208 has stored thereon computer program code that is loaded into the RAM 206 at runtime and that is executable by the processor 202. When the computer program code is executed by the processor 202, the processor 202 causes the server 108 to implement the method disclosed herein (described in more details below) (described in more detail below). Additionally or alternatively, the servers 108 may collectively perform that method using distributed computing. While the system depicted in FIG. 2 is described specifically in respect of one of the servers 108, analogous versions of the system may also be used for the user devices 104.

The processor 202 used in the foregoing embodiments may comprise, for example, a processing unit (such as one or more processors, microprocessors, or programmable logic controllers) or one or more microcontrollers (which comprise both one or more processing units and one or more non-transitory computer readable media). Examples of processors include INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like.

Examples of computer readable media that are non-transitory include disc-based media such as CD-ROMs and DVDs, magnetic media such as hard drives and other forms of magnetic disk storage, semiconductor-based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

Generally, each processor 202 comprises necessary circuitries implemented using technologies such as electrical and/or optical hardware components for executing one or more processes as the implementation purpose and/or the use case maybe, to perform various tasks. In many embodiments, the one or more processes may be implemented as firmware and/or software stored in the RAM 206 and/or the storage 208. Hardware and software are generally integrated parts of a computing device 104 or 106.

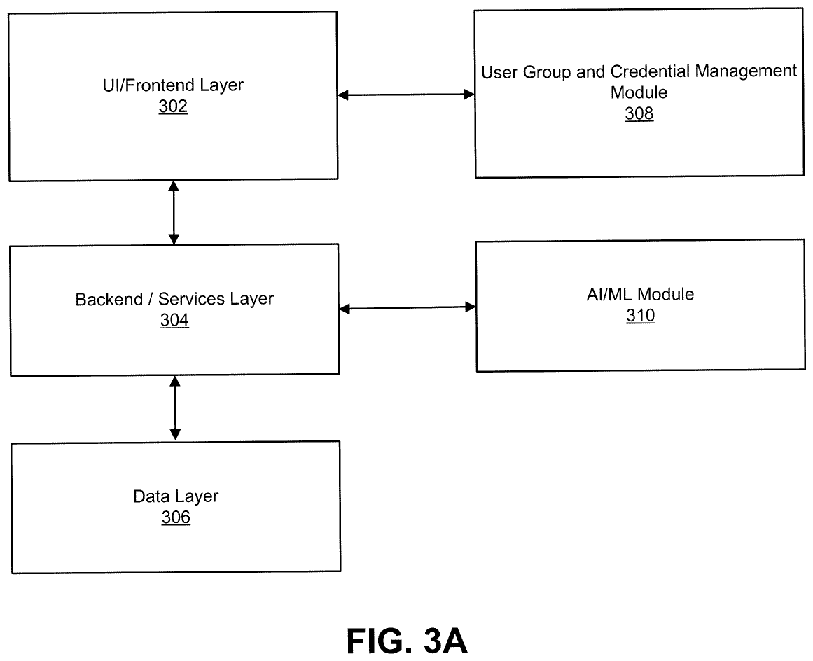

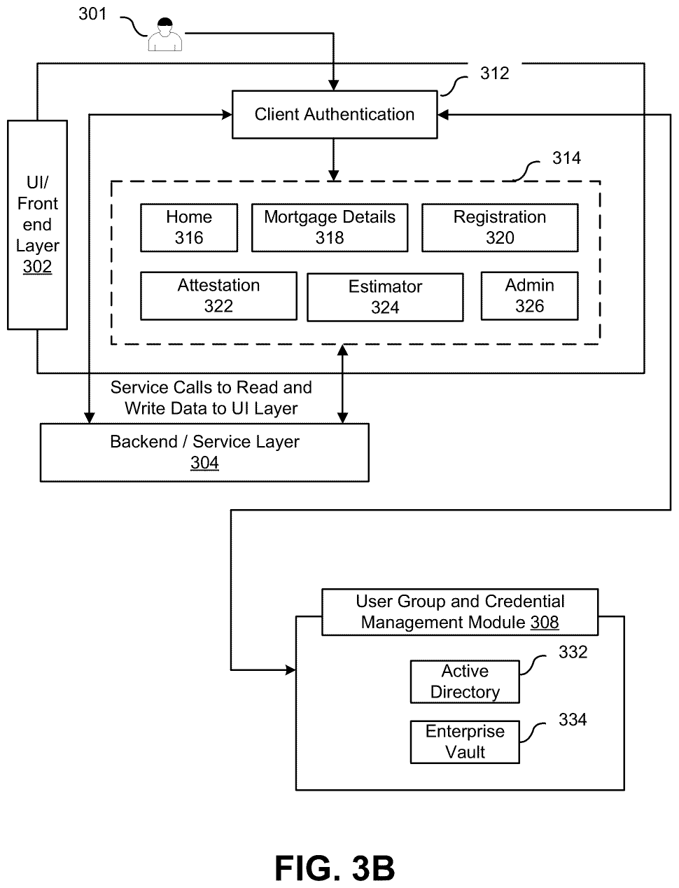

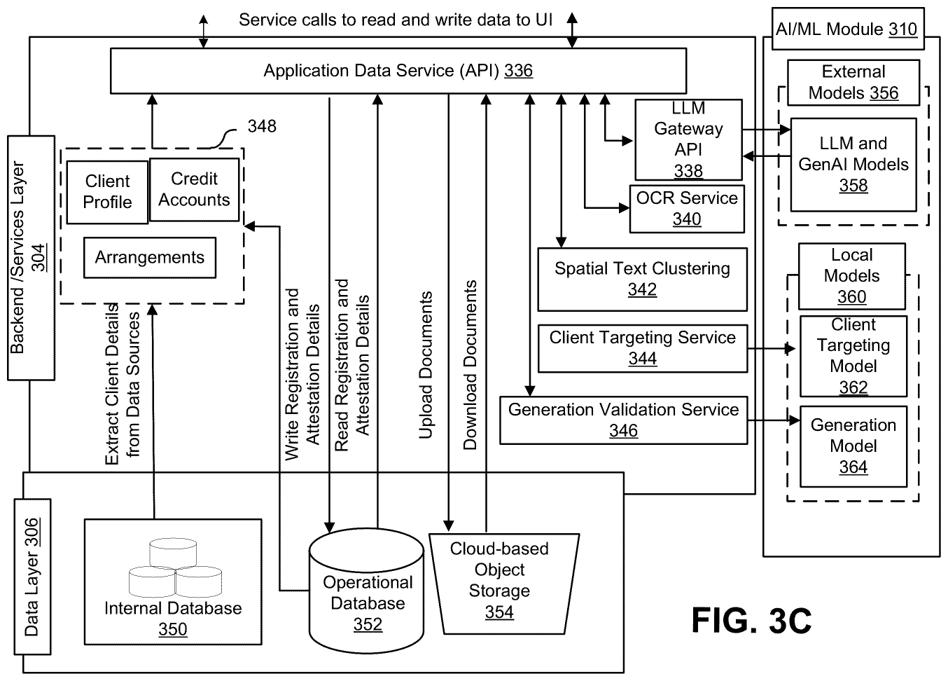

FIG. 3A is a schematic diagram showing a functional architecture 300 of the computer network system 100, according to some embodiments of this disclosure.

As shown, the computer network system 100 comprises a user-interface (UI)/frontend layer 302 (also denoted “a UI/frontend module”; see FIG. 3B) for interacting with users, a user group and credential management module 308 (see FIG. 3B), a backend/services layer 304 (also denoted a “backend/services module”; see FIG. 3C), a deployed artificial intelligence (AI) or machine learning (ML) module 310 (see FIG. 3C) comprising one or more AI models or ML models, and a data layer 306 (also denoted a “data module”; see FIG. 3C). Each of these modules comprises one or more services.

Herein, a service is a function block exposing some application programming interfaces (APIs) and containing some business logic, and may be independently deployed and dockerized. Herein, a “module” is a term of explanation referring to a hardware structure such as a circuitry implemented using technologies such as electrical and/or optical technologies (and with more specific examples of semiconductors) for performing defined operations or processings. A “module” may alternatively refer to the combination of a hardware structure and a software structure, wherein the hardware structure may be implemented using technologies such as electrical and/or optical technologies (and with more specific examples of semiconductors) in a general manner for performing defined operations or processings according to the software structure in the form of a set of instructions stored in one or more non-transitory, computer-readable storage devices or media.

As a part of a device, an apparatus, a system, and/or the like, a module may be coupled to or integrated with other parts of the device, apparatus, or system such that the combination thereof forms the device, apparatus, or system. Alternatively, the module may be implemented as a standalone device or apparatus.

FIG. 3B illustrates a block diagram of a system architecture showing details of the UI/frontend module 302 and the user group and credential management module 308.

The UI/frontend module 302 can provide an interface with a user 301 and may connect them to a client authentication module 312, which handles user authentication. The client authentication module 312 may be connected to a client module 314 (e.g., a web application) that manages client-related functions.

The client module 314 contains several components which can include but not limited to a home module 316, a mortgage details module 318, and a registration module 320, an attestation module 322 (e.g., for users to submit and manage their solar generation attestations), an estimator module 324 (e.g., for solar power generation estimation), and an admin module 326.

The client authentication module 312 may be in communication with a user group and credential management module 308, as shown in FIG. 3B. The user group and credential management module 308 may be used to handle user authentication, authorization, and secure access to the network system 100. In some embodiments, the user group and credential management module 308 may include an active directory 332 and an enterprise vault 334. The client authentication module 312 can be configured to provide security and access control services through its connection to the active directory 332 and the enterprise vault 334.

In some cases, the user group and credential management module 308 may implement session management to track user activity and maintain secure connections. The credential management module 308 may generate and manage session tokens to authenticate user requests throughout their interaction with the network system 100.

In some embodiments, the client module 314 may communicate with other components through an application data service (API) service calls to read and write data to the UI/frontend module 302.

In some cases, an access token (e.g., OAuth tokens) may be used for authentication. For example, once a user logs in through the client authentication module 312, an OAuth token may be generated and sent with every request to the backend/services module 304. The user group and credential management module 308 may manage OAuth tokens to verify the identity of users accessing the network system 100. These tokens may be used to grant secure access to various components and functionalities of the network system 100.

The various embodiments described herein leverage one or more machine learning (ML) or artificial intelligence (AI) technologies to enhance the various services and processings.

FIG. 3C illustrates a block diagram of a system architecture showing details of the backend/services module 304, the AI/ML module 310, and the data module 306, according to some embodiments of this disclosure.

The backend/services module 304 comprises an API layer 336 that interfaces between the frontend module 302 and various components of the backend/services module 304 to process and manage data and related services. The various services at the backend/services module 304 can make service calls to read and write data to the UI/frontend module 302.

In some embodiments, the backend/services module 304 may handle various functionalities of the renewable energy incentive program and the management of solar systems. The backend/services module 304 may interface with the data module 306 to retrieve and store data related to e.g., client information, registration details, attestation details, and/or documents related to solar generation.

In some embodiments, the backend/services module 304 may include a client account module 348 for extracting client details from the data module 306 and sending the extracted client details to the API layer 336. The client account module 348 may further include registration and attestation details written from the data module 306. In some embodiments, the client account module 348 may be arranged in terms of client profile, credit accounts, and arrangements.

In some embodiments, the backend/services module 304 may comprise an optical character recognition (OCR) service module 340 and a spatial text clustering module 342.

The OCR service module 340 may utilize OCR technology to extract text and relevant information from uploaded documents, such as solar installation records or energy generation reports. The OCR service module 340 may process various document formats, converting image-based text into machine-readable data for further analysis and validation.

The spatial text clustering module 342, implementing e.g., Hierarchical Density-Based Spatial Clustering of Applications with Noise (HDBSCAN) algorithms, may be used to analyze the spatial relationships between text elements extracted by the OCR service module 340, grouping related information based on their proximity and density within documents. This clustering algorithm can seek areas in the dataset where there are a large number of data points (high density) and separate these regions from areas with few data points (low density). Such an approach may help in organizing and interpreting unstructured document data more effectively, facilitating the extraction of key details from complex layouts.

In some embodiments, the backend/services module 304 may further comprise a client targeting service 344 and a generation validation service 346.

The client targeting service 344 may utilize data from various sources, including satellite imagery analysis and historical energy consumption patterns, to identify potential clients for solar installations. The client targeting service 344 may employ machine learning algorithms (e.g., through connection to a client targeting model 362 from the AL/ML module 310) to predict which properties are most suitable for solar panel installation, enabling more focused and efficient outreach strategies.

The generation validation service 346 may be used for verifying the accuracy of reported solar energy generation data from residential installations. The generation validation service 346 may employ machine learning algorithms (e.g., through connection to a generation model 364 from the AL/ML module 310) which utilize historical data, weather information, and system specifications to cross-check submitted solar energy generation figures, flagging any discrepancies for further review.

The backend/services module 304 may also comprise a Large Language Model (LLM) gateway API 338 that interfaces with LLM and/or Generative AI (GenAI) models 358. This gateway may allow the system to send prompts and receive responses from external models that leverage advanced natural language processing capabilities for tasks such as document understanding, query interpretation, and automated response generation. The LLM gateway API 338 may facilitate seamless integration with state-of-the-art language models, enhancing the system's ability to process and respond to complex user queries or document content.

The computer network system 100 may also include an AI/ML module 310, as shown in FIG. 3C. The AI/ML module 310 may be configured to analyze data, predict energy generation, and provide client targeting and validation for the renewable energy incentive program.

In some embodiments, the AI/ML module 310 may incorporate both external and local machine learning models to process and analyze solar generation data, validate submissions, and provide accurate estimations.

The AI/ML module 310 may comprise one or more external models 356 including one or more LLMs and GenAI models 358, such as those provided by OpenAI™ or Chat Generative Pre-trained Transformer (ChatGPT). These external models may be accessed through APIs to leverage their advanced natural language processing and generation capabilities. They may assist in tasks such as interpreting complex document structures, generating responses for user queries, or providing insights from unstructured data related to solar installations and energy generation.

The AI/ML module 310 may further comprise one or more local models 360 which are tailored to specific tasks within the renewable energy incentive program:

A client targeting model 362 may be provided utilizing neural networks and clustering techniques to identify potential clients for solar installations. In some embodiments, the client targeting model 362 may implement a UNet architecture for binary semantic segmentation, applying transfer learning to a base UNet model with modifications to the model architecture. This approach may enable the system to analyze satellite imagery or other visual data to determine the suitability of properties for solar panel installation.

In some embodiments, the UNet model may be used for image segmentation. The UNet model may be used to analyze plan-view images of housing structures to determine their suitability for solar system installation.

In some embodiments, the UNet model may be used to extract roof features from plan-view images of housing structures. In some cases, the client targeting service 344 may then attempt to fit a representation of one or more solar panels into the extracted roof feature. The client targeting service 344 may determine the suitability of the housing structure for solar system installation based on this fitting process.

In some embodiments, a generation model 364 may be provided implementing a time series forecasting model such as Long Short-Term Memory (LSTM) neural networks to forecast and validate solar energy generation. The LSTM model may be trained on historical solar generation data and corresponding weather information stored in the data module 306. This training may enable the LSTM neural network to learn patterns and relationships between weather conditions and solar energy production. The model can incorporate hyperparameter tuning capabilities to optimize its performance and accuracy over time.

In some embodiments, the AI/ML module 310 may be responsible for validating received solar generation data. The generation validation service 346 may extract features from the received solar generation data. These extracted features may then be input into the trained LSTM neural network for validation.

The AI/ML module 310 may generate a validation score based on the output of the LSTM neural network. This validation score may indicate the likelihood that the received solar generation data is accurate and consistent with expected patterns. The validation score may be used by other components of the computer network system 100, such as the generation validation service 346, to determine how to process or utilize the solar generation data.

The AI/ML module 310 may also be used to assist in the estimation of potential solar power generation for housing structures. This estimation may be based on various factors, including but not limited to the extracted roof features, the potential solar panel placement, and/or historical weather data for the location.

In some cases, the AI/ML module 310 may use satellite imagery to validate reported system sizes of solar installations. This process may involve analyzing images of residential properties to verify the dimensions and configuration of installed solar panels.

In some cases, the AI/ML module 310 may estimate the roof tilt angle from satellite images of housing structures. This estimated tilt angle may be used to refine the potential solar power generation estimates and improve the accuracy of suitability determinations.

By leveraging both external and local models, the AI/ML module 310 may provide accurate, personalized information to homeowners, enable precise predictions of solar energy generation potential, and optimize incentive calculations based on individual property characteristics. The module may continuously update and refine its models based on new data received by the network system 100, improving the accuracy of predictions and validations over time and enhancing the overall performance of the renewable energy incentive program.

The computer network system 100 may further include a data module 306, as shown in FIG. 3C.

The data module 306 can manage data access, storage, and retrieval across various databases and storage systems and be designed to ensure data integrity, optimize performance, and provide efficient data management for the renewable energy incentive program.

In some embodiments, the data module 306 incorporates three data storage components:

An internal database 350 can serve as a central repository for system data. It may store user profiles, solar installation specifications, historical energy generation data, and/or renewable energy certificate information. The internal database may be optimized for quick access to frequently used data and may implement caching mechanisms to improve retrieval performance.

An operational database (e.g., PostgresDB) 352 may be specifically designed for handling read and write operations related to registration and attestation details. In some implementations, the operational database 352 may utilize PostgreSQL™, an open-source relational database system, to provide support for complex queries and transactions. The operational database 352 may store detailed information about user registrations, solar system specifications, and periodic attestations of energy generation. Its structure allows for efficient data retrieval and updates, supporting the day-to-day operations of the renewable energy incentive program.

A cloud-based object storage 354 may utilize cloud-based object storage, such as Amazon™ Simple Storage Service (S3™) bucket or a similar service, for document management. The S3 bucket may be designed for uploading and downloading various documents related to the renewable energy incentive program. These may include registration forms, attestation documents, system installation reports, and other supporting files. The object storage 354 can provide scalable and durable storage for large volumes of unstructured data, allowing for easy retrieval and management of documents.

For performance optimization, the data module 306 may implement caching mechanisms, storing frequently accessed data in memory for faster retrieval. It may also employ data compression techniques, particularly for historical data in the S3™ bucket, to optimize storage utilization while maintaining data accessibility.

In some cases, the data module 306 may utilize a Facebook™ AI Similarity Search (FAISS) vector database to store embeddings. The FAISS vector database may be used in conjunction with document validation processes, allowing for efficient similarity searches and clustering of document features.

In some cases, the data module 306 may utilize Open Source Computer Vision Library (OpenCV) for connected component analysis. The OpenCV library may be used to isolate individual houses in image data, supporting various image processing tasks within the network system 100.

With the functional architecture 300, the computer network system 100 provides a portal for mortgage clients to sell the rights to their renewable generation in the form of REC to an organization, such that the organization can offset its own emissions, closer to the source.

In some implementations, a client can be authenticated through the frontend module 302 upon accessing the system. The client authentication module 312 may process the login, setting e.g., an OAuth token in the cookies for subsequent backend requests, ensuring secure communication throughout the session.

Subsequently, the client may be prompted to select the mortgage having solar on. The client module 314 can interface with the data layer module 306 to retrieve mortgage information associated with solar installations via a suitable API.

For unregistered clients, the registration module 320 may present a registration form pre-populated with client information retrieved from the data module 306 via a client-profile API. The client account module 348 can facilitate document upload containing system specifications and expected generation data.

The client can be prompted to upload a document from their solar provider that contains the system size (e.g., in kilowatts), and the annual expected generation.

According to some embodiments, the system provides an analyzing process that may be prompted by the client (via the client pressing an “Analyze” button on the interface) to analyze the uploaded document.

The analyzing process can comprise two processes within the backend/services module 304, including a key detail validation process and a detail extraction process.

The key detail validation process can ensure that key details (which exist in most installation documents) exist in the uploaded document such as financial and emissions savings.

The detail extraction process extracts details such as the system size and annual expected generation. This can be done by extracting the text and bounding boxes by the OCR service module 340, then clustering the text based on the location on the page with the HDBSCAN algorithm employed by the spatial text clustering module 342 to group related information.

The artificial intelligence module 310 can then utilize external models 358, such as Generative Pre-trained Transformer (GPT), to generate embeddings. These embeddings may be temporarily stored in a database (e.g., a temporary in-memory FAISS vector database) for efficient similarity searches.

After that, the most relevant clusters to the queries, seeking the key and extraction details, may be found by using, for example, the Retrieval Augmented Generation (RAG) techniques and LangChain™ (which is a framework to build with LLMs by chaining interoperable components). Finally, the most relevant clusters can be sent to the LLM and GenAI models 358 to structure data. If information is missing or inconsistent, the registration may be flagged for manual review through the admin interface 326.

Once the document is analyzed and key information validated, the user may be given an opportunity to register by e.g., clicking on the registration button. Upon registration submission, the generation validation service 346 can employ an LSTM ML model to validate the expected energy generation, which uses weather data to predict how much solar power (e.g., in kilowatt per hour (kWh)) the system should expect to generate in the year. This model, part of the local models 360, incorporates various environmental and system-specific features to predict annual solar power generation. Such prediction can be used to ensure that the uploaded document is legit and has not undergone manual changes. The model may give a validation score of how likely the generation submitted by the user is real. Various features such as temperature, wind speed, cloud cover, year, month, latitude, longitude may be used to predict the expected annual generation. System size may be used to calculate the entire solar system area, which is multiplied with the predictions output from the model to return the final monthly solar power generation predictions (e.g., in kWh). If satellite imagery exists for the home, and shows the solar panels on their roof, the solar panels in the satellite image can be used to calculate the area and match the capacity the user submitted. The latitude and longitude can also be used to get hourly weather data for the previous year from an external API, and it can be transformed into monthly averages. The model can use those monthly averages to predict the yearly generation.

If the results are not similar, the registration can be flagged for manual validation. For example, if the model's prediction is more than a certain percentage (e.g., 10%) away from the user's submission, the registration can be flagged for manual review.

Once validated the registration file may be uploaded to the data layer 306, and registration details are stored in the database. The registration details may include but are not limited to client identification, mortgage identification, file identification, submitted system size, submitted expected generation, flag, and the like. Registration details may be stored in the operational database 352 within the data layer module 306, while documents can be uploaded to the cloud-based object storage 354 for secure storage and retrieval.

After the user is registered, they can view their dashboard which can contain registration details and the option to download their submitted file, as well as their attestation details, their payments, and emissions savings.

Annual attestations may be allowed to be submitted, e.g., at the end of each year. If the registration is valid, users can attest by uploading a document with the generation for the year (e.g., a screenshot of their solar application).

The attestation interface 322 allows users to submit annual solar power generation data, which can be subject to a similar document validation process with e.g., the annual generation as the extraction details, and a graph and/or months of the year as the key details for validation. The validation can be done by comparing the extracted information with the validated registration's expected generation. Then the attestation details can be saved, and file is uploaded to the data layer 306.

The admin interface 326 facilitates manual review of flagged submissions and management of the attestation period.

The administrator can review all invalid registrations and attestations in the app, and view, then select the submissions to manually review. If deemed valid, a check can be clicked; and if not deemed valid, it may tell the user to contact the administrator or a suitable staff for more details.

Once everyone has attested for the year, an administrator can go to the administration dashboard and download all valid attestations in a suitable format such as the comma-separated value (CSV) format, and pay the clients with suitable tools. The payment may also be made automatically once the attestation is validated.

Once paid, the clients being paid and the payment amounts can be uploaded to save that information in the database.

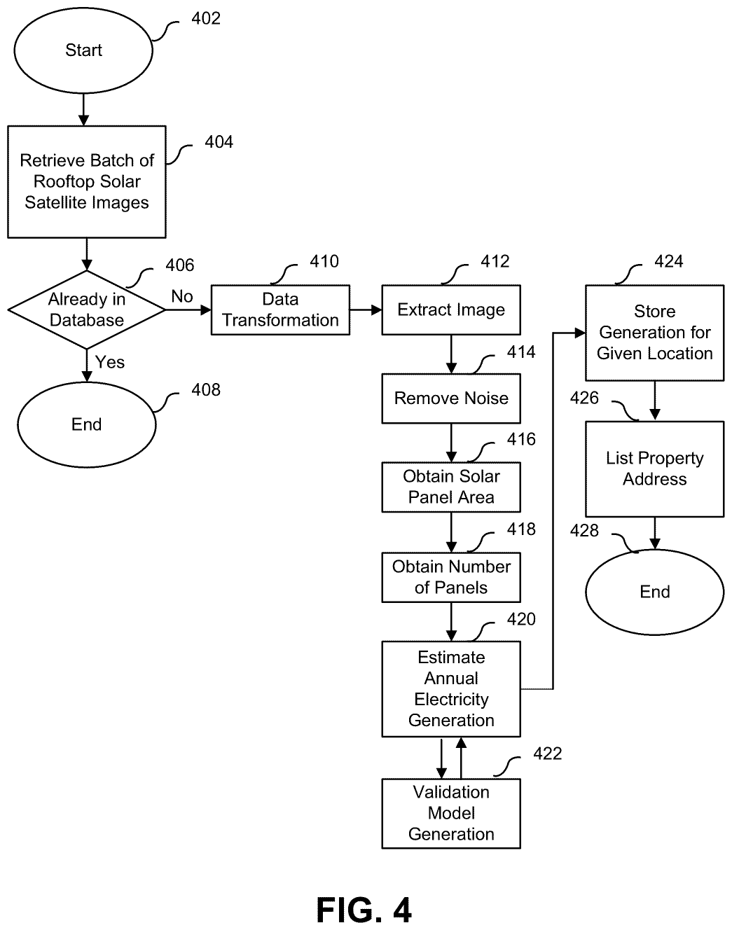

In some embodiments, the system 100 uses an image-based solar energy estimation method for targeting clients based on two categories: clients with solar and clients without solar. FIG. 4 is a flowchart showing the steps of an image-based solar energy estimation method, according to some embodiments of this disclosure.

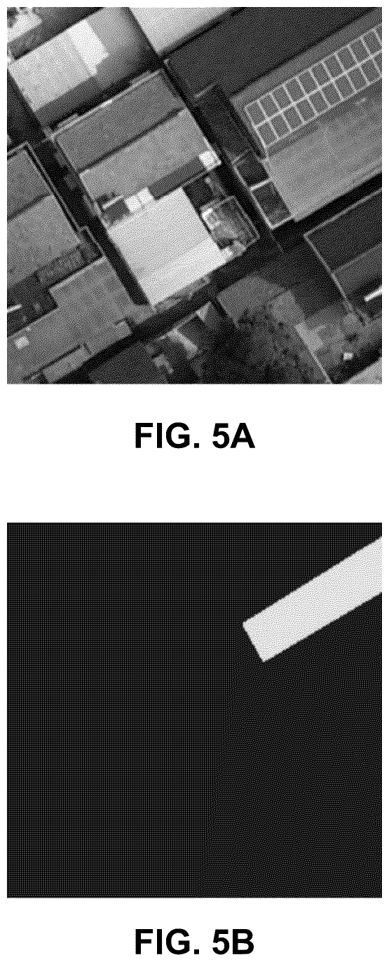

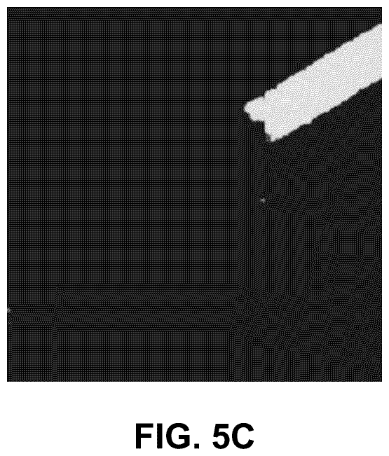

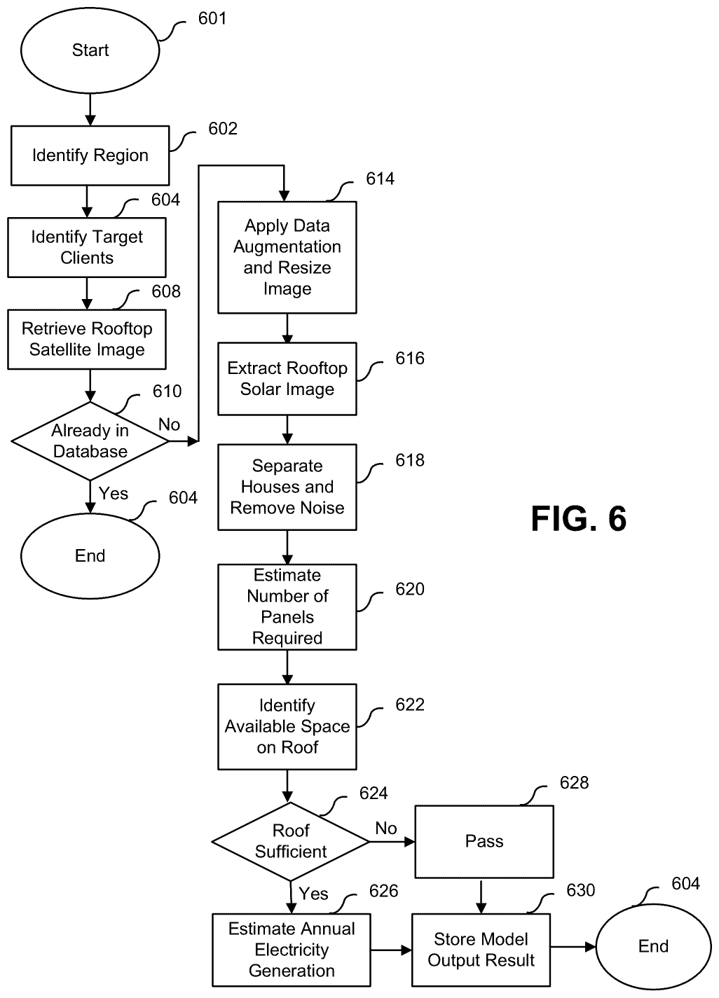

As shown in FIG. 4, for clients with solar, the system 100 can make use of aerial images of residential rooftops to identify existing solar panels on a client's home, for example, at step 404, retrieving one or more batches of rooftop solar satellite images from a database such as third-party team database. An example of the satellite image is shown in FIG. 5A.

If the satellite images are already in the database (step 406), the process will end at step 408. If such satellite images are not already in the database (step 406), the retrieved aerial images can be transformed to appropriate dimensions (e.g., 250 by 250) and/or appropriate format (such as png) (step 410) before they are fed into the model for analysis.

In these embodiments, the system 100 uses a suitable tool to extract details about the solar panels. For example, at step 412 the system 100 may use a UNet model to perform binary image segmentation in order to extract rooftop solar images, creating a predicted image mask (such as binary image mask) of the isolated solar panels as foreground pixels (for example, white, representing the solar panels) from background pixels (for example, black; representing non-solar-panel areas).

At step 414, the system 100 then identifies connected components and/or cleans up small noises from the image mask to remove isolated islands of pixel clusters. An example of the predicted image mask after cleaning is shown in FIG. 5B. As a comparison, FIG. 5C shows a “true” mask obtained manually using necessary image processing but without using the UNet model.

Upon cleaning this image mask, the available solar panel area (e.g., per-pixel-area) in this mask can be calculated and obtained at step 416 using the spatial resolution information about the image. The total number of pixels for the solar panels can be counted, and the per pixel area can be calculated based on the image spatial resolution. The total area of the solar panels on the roof can then be calculated based on the counted total number of pixels for the solar system and the per-pixel-area size.

In some embodiments, the tilt angle of the roof may be estimated based on the satellite image (for example, using the skimage package, which is a collection of algorithms for image processing), and then the calculated panel area can be adjusted based on the tilt angle of the roof.

At step 418, the number of solar panels may also be calculated and obtained using average panel area (that is, the average size of a solar panel) and the total available panel area estimated from the satellite image.

A solar-power generation validation model 422 can be used to obtain estimate for latitude, longitude and system size and at step 420, the generation validation model 422 can be used for estimating the annual electricity the household can generate, based on the location (for example, the latitude and longitude of the property in the satellite image), the estimated number of solar panels, the average power of a solar panel, and/or the like. The estimated annual electricity is stored in a database for the corresponding location of the property in the satellite image (step 424). The estimated annual electricity generation and the corresponding property address may be listed for user's viewing (step 426). The process can end at step 428.

In some embodiments, the system 100 uses an image-based client targeting method to identify clients without rooftop solar. More specifically, the system 100 uses a suitable way to identify regions of potential interest to target clients who would benefit from adopting rooftop solar.

FIG. 6 is a flowchart showing the steps of an image-based client targeting method, according to some embodiments of this disclosure.

The process starts at step 601. As shown in FIG. 6, the system 100 may make use of publicly available photovoltaic potential data from an organization such as the Government of Canada to identify (step 602) regions of high photovoltaic (PV) potential as these regions benefit the most due to abundant solar energy annually.

Once the system 100 identifies such a region to target, the system 100 makes use of client demographics dataset to analyze inherent trends in the data by using HDBSCAN to generate density-based clusters of key features, that is, identifying clusters based on demographic data such as income level, house types, age, gender, and/or the like. These clusters represent the key features that guide the decision to identify (604) target clients in a specific region.

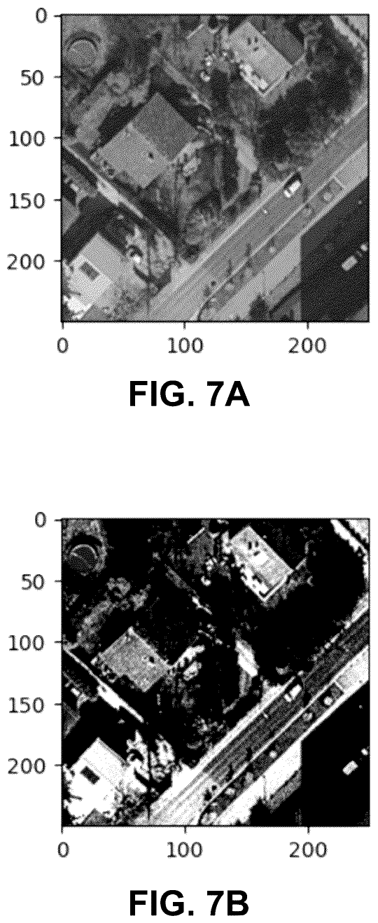

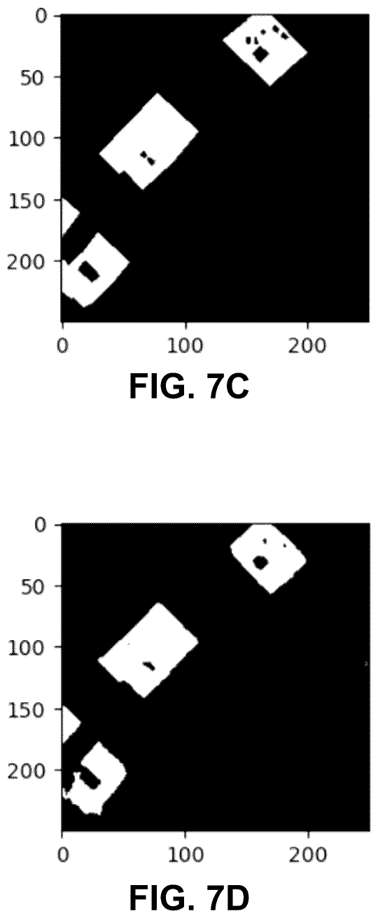

After filtering specific locations from the identified region, the system 100 can obtain one or more batches of satellite images of rooftops, e.g., from a third party team database, to identify ideal rooftops of clients that can install solar system on their roof (step 608). An example of the satellite image is shown in FIG. 7A.

If the satellite images are already in the database (step 610), the process will end at step 604. If such satellite images are not already in the database (step 610), the retrieved aerial images are processed by, for example, applying data augmentation, resizing to appropriate dimensions (e.g., 250 by 250), transforming to appropriate format (such as png), and/or the like (step 614) before they are fed into the model for analysis. An example of the transformed image is shown in FIG. 7B.

In some embodiments, the system 100 can extract rooftop solar image by making use of a UNet model to perform binary image segmentation to identify available rooftop area (step 616). An example of the image mask is shown in FIG. 7C.

In some embodiments, individual houses can be isolated from the generated image mask by OpenCV (which is a library of programming functions mainly for real-time computer vision) to perform connected component analysis separating components and removing noisy pixels from image mask.

At step 618, the system 100 may also make use of connected component analysis technique using the OpenCV library to isolate and separate individual houses and remove noisy pixels from the image. An example of the cleaned image mask is shown in FIG. 7D.

Using the spatial resolution details of the image and counting the total pixel area in each individual house, the system 100 can calculate per-pixel-area and total area of available rooftop space. Since solar systems do not cover the entire roof, using the average panel area and average panel power, the system 100 approximates the number of panels required to produce annual electricity equivalent to the targeted regions PV potential (step 620).

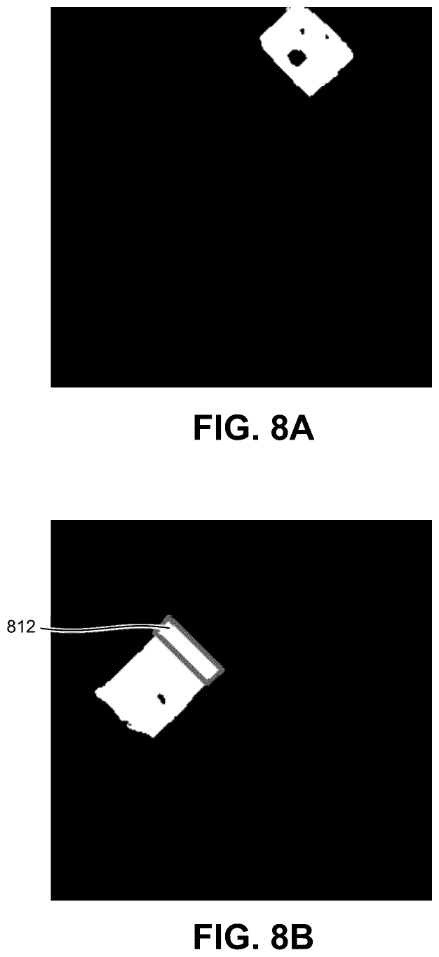

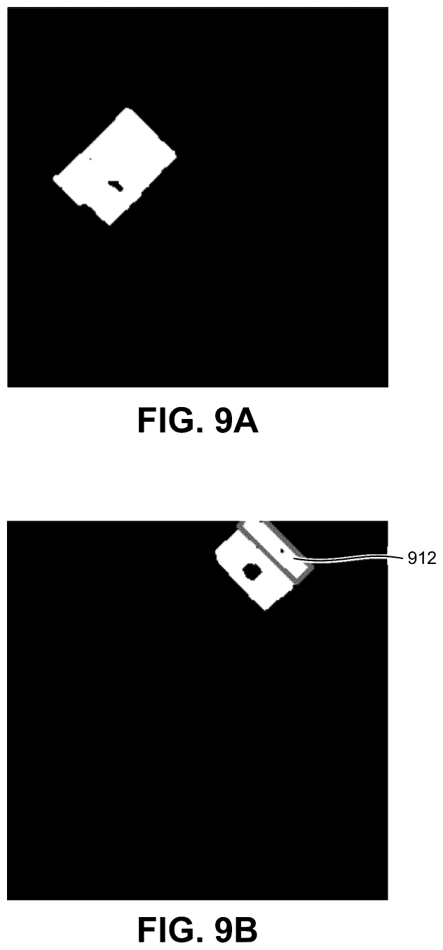

The system 100 then performs search to find an optimal orientation of panels to place on the available roof area to confirm if sufficient space exists on the roof to place an adequate number of solar panels based on the estimated number of panels required, the available roof area, and average panel area (step 622). FIGS. 8A and 8B show an example of a roof (FIG. 8A) and possible placement of a solar panel 812 thereon (FIG. 8B). FIGS. 9A and 9B show another example of a roof (FIG. 9A) and possible placement of a solar panel 912 thereon (FIG. 9B).

In some embodiments, the dimensions of a bounding box representing a solar system arrangement required to produce annual electricity equivalent to the region's PV potential can be calculated and used to verify if the isolated rooftop contains sufficient area to place panels. In some implementations, searches may be performed (by way of e.g., OpenCV template matching) over identified components (such as individual houses) to find a unique orientation of panels to place on the rooftop. A result may be returned (e.g., a Boolean result) as to whether or not a solar panel can be placed to the roof of the property.

If such an orientation exists and the roof has sufficient area for solar panels (step 624), the system 100 may return an indication (such as “true”) to confirm that the client is a suitable candidate for adopting a rooftop solar system. The annual electricity generation can also be estimated (step 626) based on the number of solar panels and the average panel power as described above. The process then goes to step 630.

If, at step 624, no such orientation exists or the roof does not have sufficient area for solar panels, the system 100 may return another indication (such as “false”) to mark the client as unsuitable to target for installing a solar system (step 628).

The model returns for the processed batch of client images, the locations of clients who would be suitable to install a rooftop solar system, their estimated electricity generation and/or flag for available roof area for the satellite image, may be stored (step 630). The property addresses with estimated annual electricity generation may be listed and the process ends at step (604).

Using the output from the above two models, the system 100 may then send outreach emails to clients highlighting the annual monetary value they can receive from an incentive program.

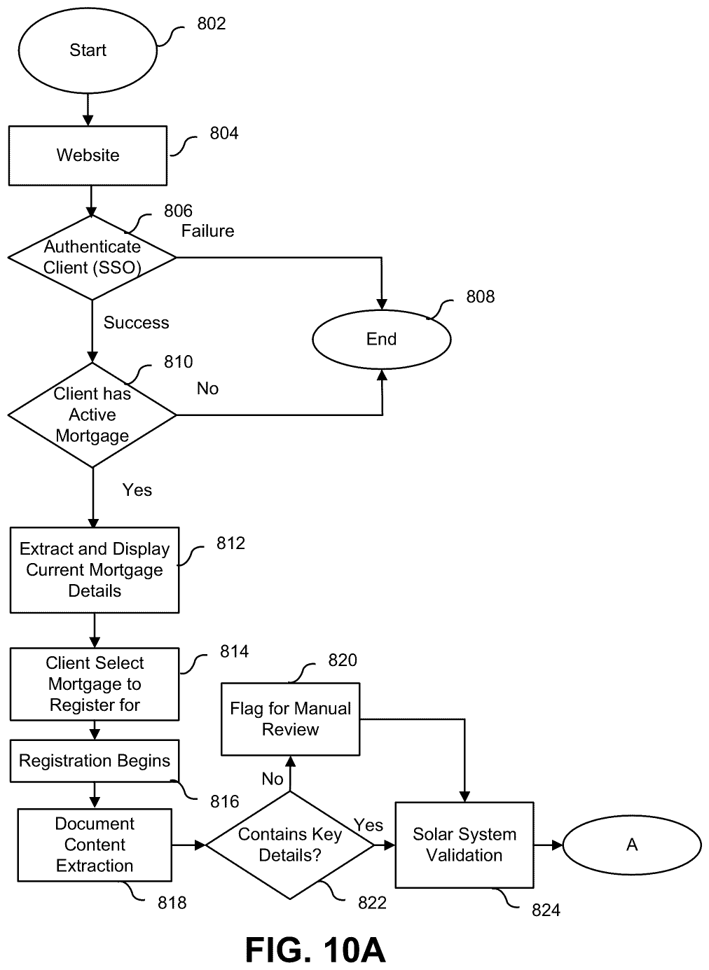

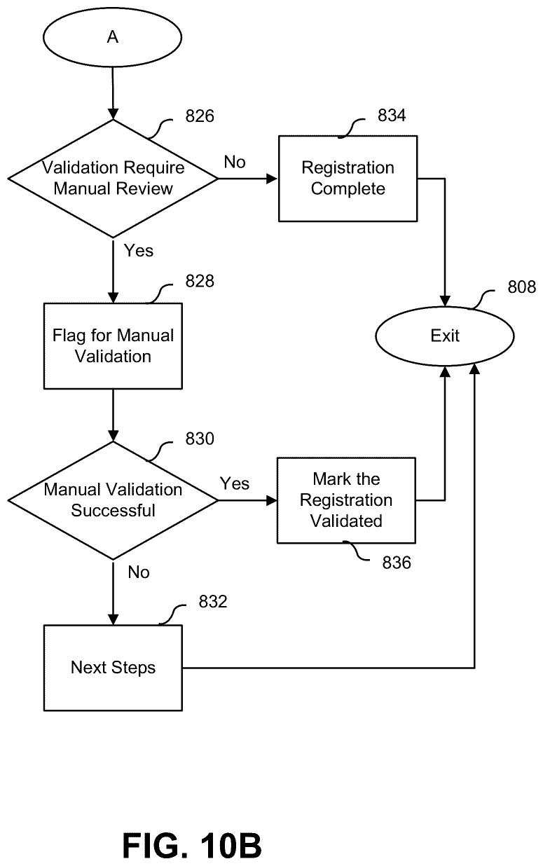

FIG. 10A and FIG. 10B provide a flowchart showing a user registration procedure for the renewable energy incentive program. The procedure may comprise multiple processes, including user authentication, mortgage selection, document content extraction, solar generation validation, and registration completion.

The procedure begins at step 802 and proceeds (step 804) to a landing interface or website. Following this, the procedure can move to an authenticate client step 806, where single sign-on (SSO) authentication can occur. During this step, the system may interface with the data module 306 to find the existing user and match the hash of the provided password with the hash stored in the database, ensuring secure authentication.

If authentication fails, the procedure proceeds to an end step 808. If authentication is successful, the procedure can continue to a decision step 810 to check if the client has an active mortgage. This step may involve making a call to the data module 306 with the user identification, querying client arrangements to find existing mortgages, and accessing credit accounts to retrieve mortgage details.

If the client does not have an active mortgage (“No” branch), the procedure may proceed to the end step 808. If the client has an active mortgage (“Yes” branch), the procedure can move to step 812 where current mortgage details are extracted and displayed. For example, backend/services module APIs 336 may be used to pull client information from the data module 306. The procedure can then proceed to step 814 where the client selects a mortgage to register for.

Registration can begin (step 816) by loading a registration form that may be pre-populated with client details. The client can upload a solar installation document from a vendor for the selected mortgage property. The registration interface may prompt the client to analyze the uploaded document (e.g., by pressing the “Analyze” button).

Upon initiation, the procedure can proceed to analyze the document by including a document content extraction step 818. This process, which is described in more detail below, can involve analyzing uploaded documents to extract information about the solar installation, including for example, an OCR process to extract the text content from the document, an HDBSCAN process to cluster information based on location; a RAG process to send in most relevant data, and a GEN AI process to locate and pull specific details (e.g., size of the system and expected generation) from the installation document using prompt engineering. The extracted response can be populated into the respective fields on the registration form.

Following the registration, at step 822, the procedure can check if the document contains key details for installation document. If the document contains key details (“Yes” branch), the procedure may move to step 824 for solar system validation. This validation process, also described in more detail below, can involve validating that the extracted content aligns with solar generation using a machine learning model. If the document does not contain key details (“No” branch), the procedure may proceed to step 820 to flag for manual review.

From the solar system validation step 822, the procedure may proceed to a validation decision step 826 that determines whether manual review is required based on the results of the solar system validation (e.g., a score generated by the validation model). If manual review is not required (“No” branch), the process may proceed to step 834 where registration is marked as complete. At this step, a notification or email may be sent to the client with the registration details.

If manual review is required (“Yes” branch), the process may move to step 828 where the registration is flagged for manual validation. Following the flagging, the process may continue to a validation success decision step 830 which determines if the manual validation is successful.

If the manual validation is successful (“Yes” branch), the process may move to step 836 where the registration can be marked as validated. After validation, the process may proceed to save the registration. This can involve storing the registration details in the database and uploading associated files to the data module 306.

If the manual validation is not successful (“No” branch), the process may move to step 832 which prompts the client to contact advisor for obtaining validation of the registration before proceeding to exit step 808.

Upon successful registration, the system may display a post-registration dashboard to the user, providing access to their registration details, uploaded documents, and other relevant information.

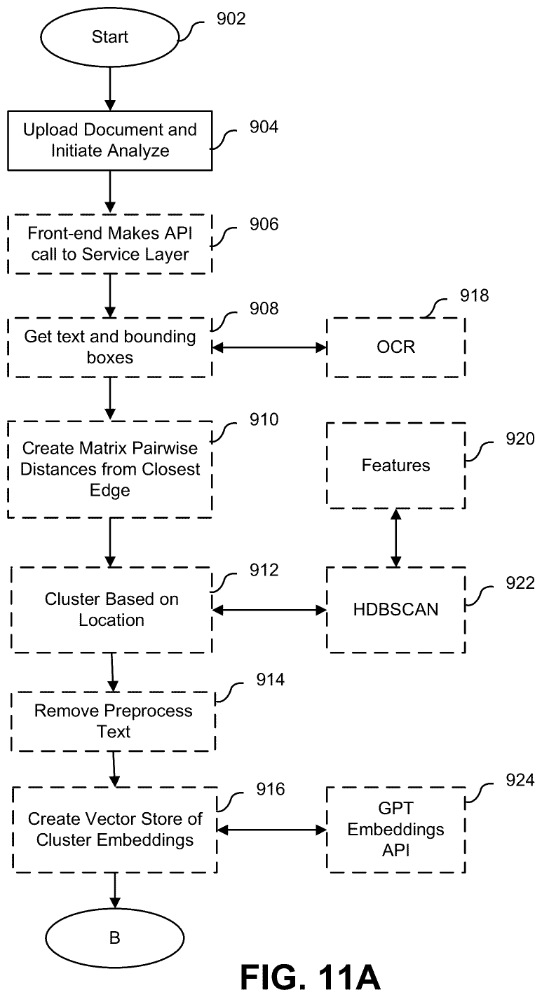

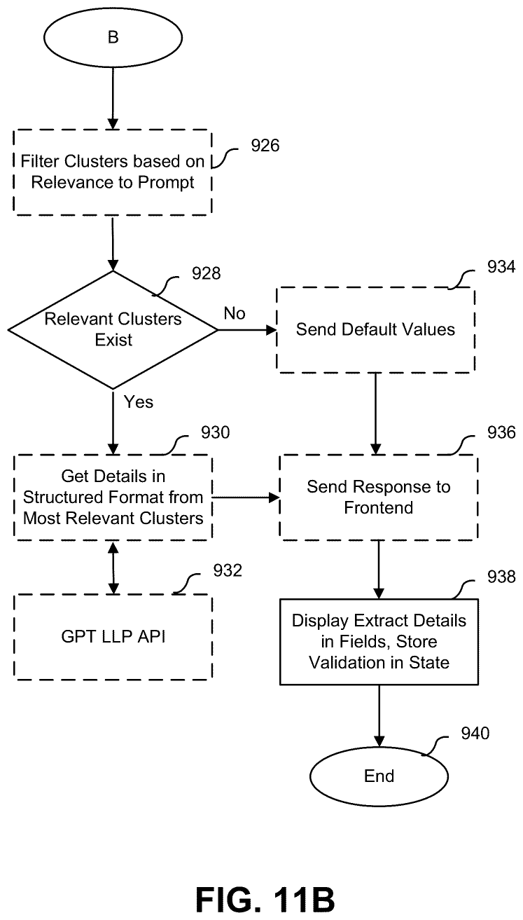

FIG. 11A and FIG. 11B are a flowchart showing a document content extraction procedure for processing and analyzing documents related to solar installations and energy generation, according to some embodiments of this disclosure. According to some embodiments, the procedure may incorporate advanced text recognition, clustering, and natural language processing techniques to extract and validate key information from uploaded documents.

FIG. 11A begins with steps 902 and 904 where a document is uploaded and the analyze process is initiated. At step 906, the front-end may make an API call to the backend/services module 304 to begin processing.

The procedure may then proceed to step 908, where text and bounding boxes are obtained. In some embodiments, this step may interface with the OCR module 918, which employs a suitable OCR function (such as TesseractOCR, OCR Page Segmentation Mode 3 (PSM 3)) to extract text and their locations from the document.

At step 910, the procedure may create, for each bounding box, a matrix of pairwise distances from the closest edges of the extracted text bounding boxes. This step may also involve preprocessing the extracted text by for example, removing empty text and/or white space, converting all characters of the text to lowercase, and/or the like.

The procedure then may move to step 912 for clustering based on location. This step may interface with both a features module 920 and an HDBSCAN module 922. The HDBSCAN algorithm may be used to cluster words based on their physical location on the page. The features considered for clustering may include pairwise edge distances between text elements, as well as the width and height of the bounding boxes. The backend/services module 304 may use for example, HDBSCAN to cluster the words of the recognized text based on their page locations, for example, the pairwise edge distances of the corresponding bounding box, the size (such as the width and heigh) of the corresponding bounding box, and/or the like, and create vector store of embeddings (stored in, for example, FAISS vector database).

At step 914, the procedure may remove preprocessed text, preparing the data for the next stage of processing.

The procedure may then proceed to step 916 to create a vector store of cluster embeddings. This step may interface with a GPT embeddings API 924 to generate embeddings for each cluster. These embeddings can then be stored in a FAISS vector store for efficient similarity searches and retrieval.

When a prompt for key document details is inputted or otherwise created, the clusters may be filtered based on the relevance to the prompt to find relevant clusters. A LLM can be then used to parse through relevant clusters and generate the extracted details.

The process continues at step 926, where clusters may be filtered based on their relevance to a prompt. This prompt may be created to identify key document details (may be referred to as “key document features”) and specific installation or generation information to extract (referred to as “extraction details”). For example, an example of the prompt may be: “what is [extraction details]? Does this have [key document features]?” Key document features may be those that are common within the examples of installation and generation documents. Extraction details for registration may include system size (in kilowatt (kW)) and expected annual production; and extraction details for attestation may include annual generation. The filtering process may utilize LangChain™ embeddings filter and compression retriever to identify the most relevant clusters.

Following this filtering operation, it may be determined at step 928 whether relevant clusters exist. If no relevant clusters are found (“No” branch), the process may move to step 934, where default values are sent. If relevant clusters do exist (“Yes” branch), the process may proceed to step 930.

At step 930, the system may obtain details in a structured format from the most relevant clusters. This may involve using Retrieval Augmented Generation (RAG) techniques based on the most relevant clusters, interfacing with an LLM through the GPT API for queries.

For registration purposes, the details may include expected generation power in kWh, system size in kW, and/or a Boolean value as to whether key features are contained; for attestation purposes, the details may include annual generation power in kWh, and/or a Boolean value as to whether key features are contained.

From step 930, the process may continue to step 932, which involves utilizing the GPT LLP API to further parse through relevant clusters and structure the extracted information.

Following both the GPT LLP API operation and the default value sending (if applicable), the process may move to step 936, where a response is sent to the frontend.

At step 938, the extracted details may be displayed in fields and validation information stored in the system state. In some embodiments, the extracted information may be structured into a JavaScript™ Object Notation (JSON) format using a LangChain™ output parser, ensuring a standardized and easily processable output.

Finally, the process concludes at step 938.

Table 1 below shows an example of the document validation details and extraction details.

TABLE 1

| | Document | |
|---|---|---|
| | Validation Details | Extraction Details |
| Registration | Emissions Savings | System Size (kW) |
| | Financial Savings | Expected Generation (kWh) |
| Attestation | Graph of Generation | Annual Generation (kWh) |

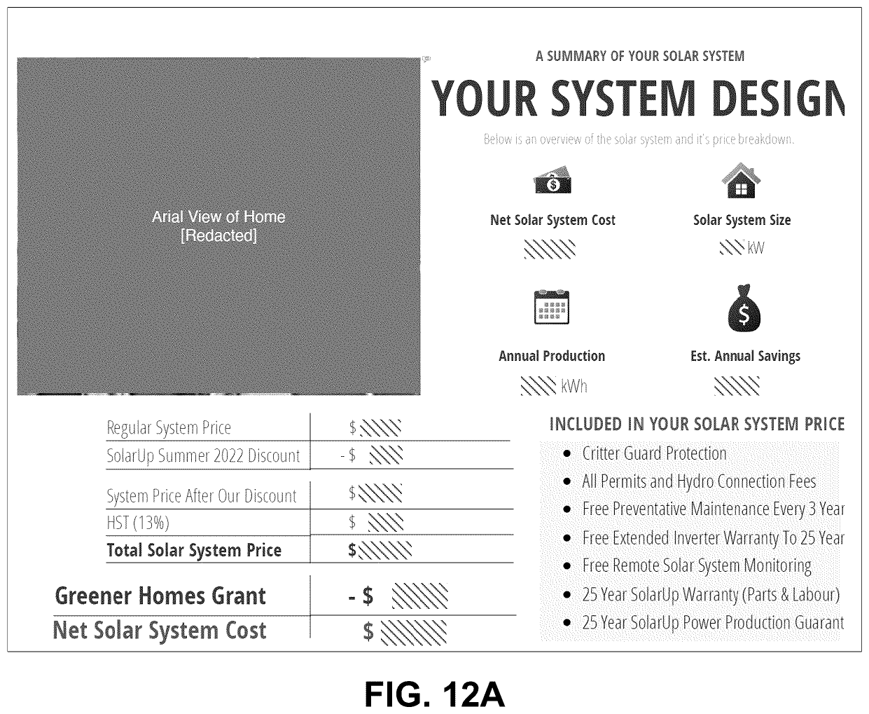

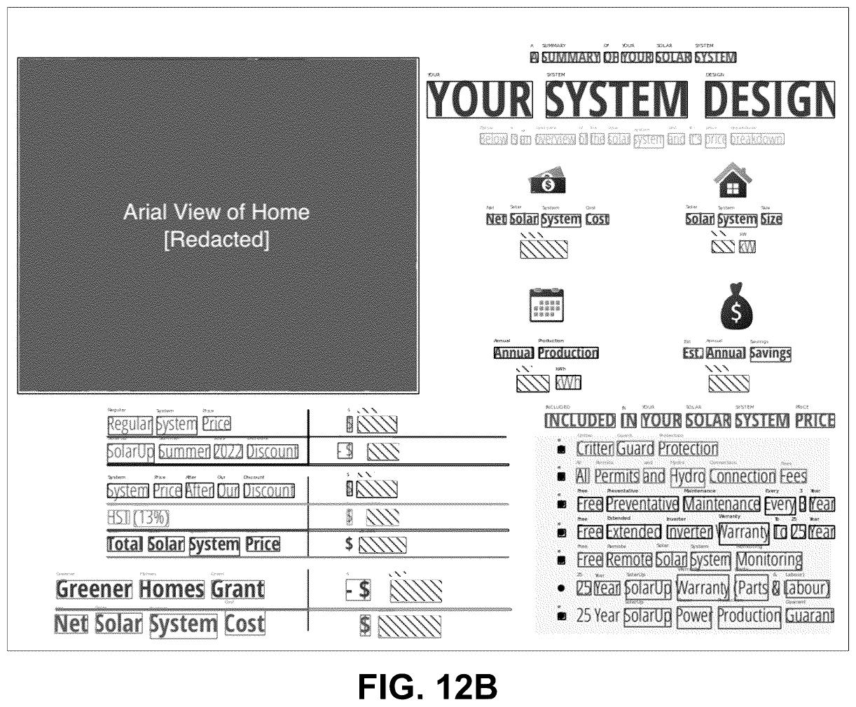

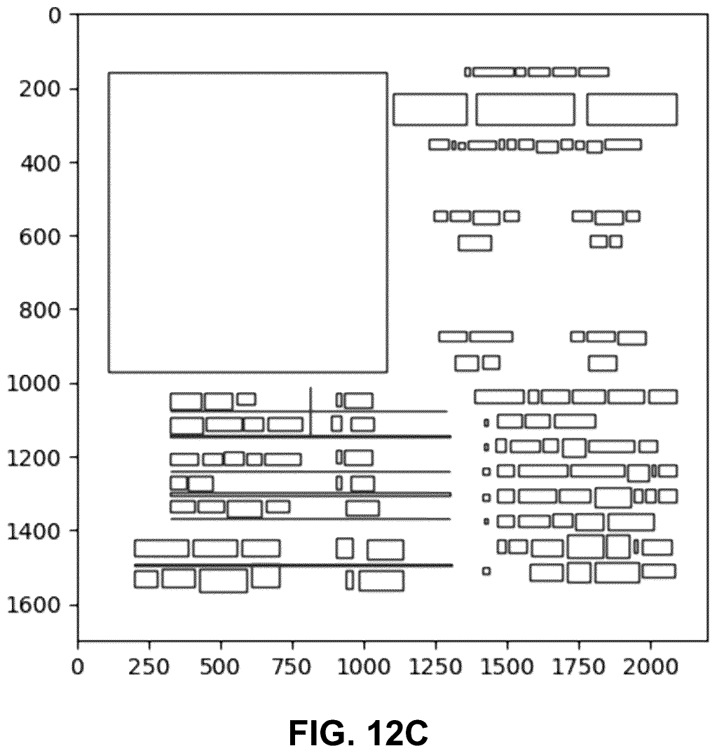

FIG. 12A shows an example of a document image. FIG. 12B shows the recognized words and their corresponding bounding boxes. FIG. 12C shows the bounding boxes without the recognized words for better illustration of the bounding boxes.

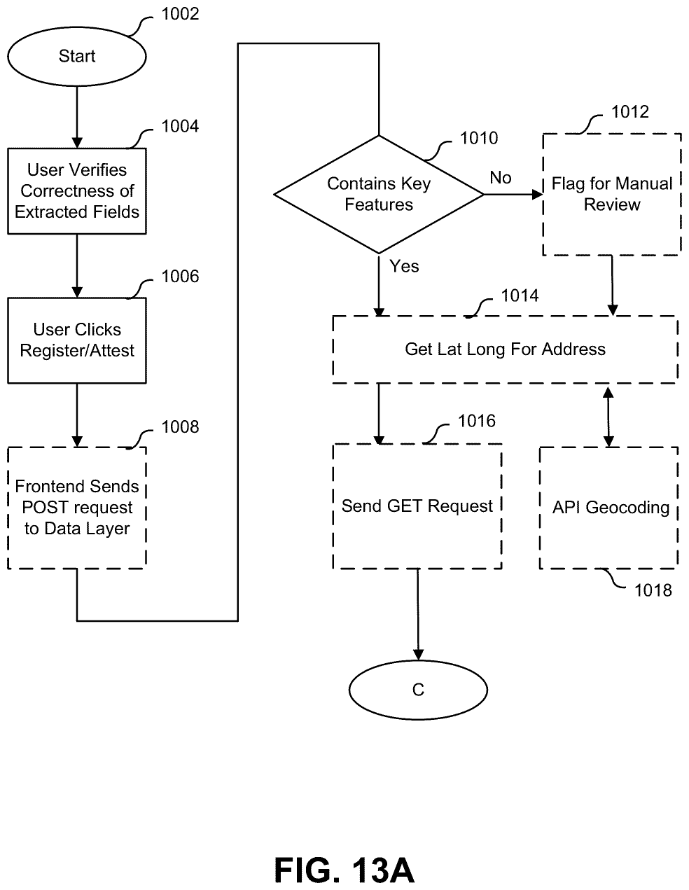

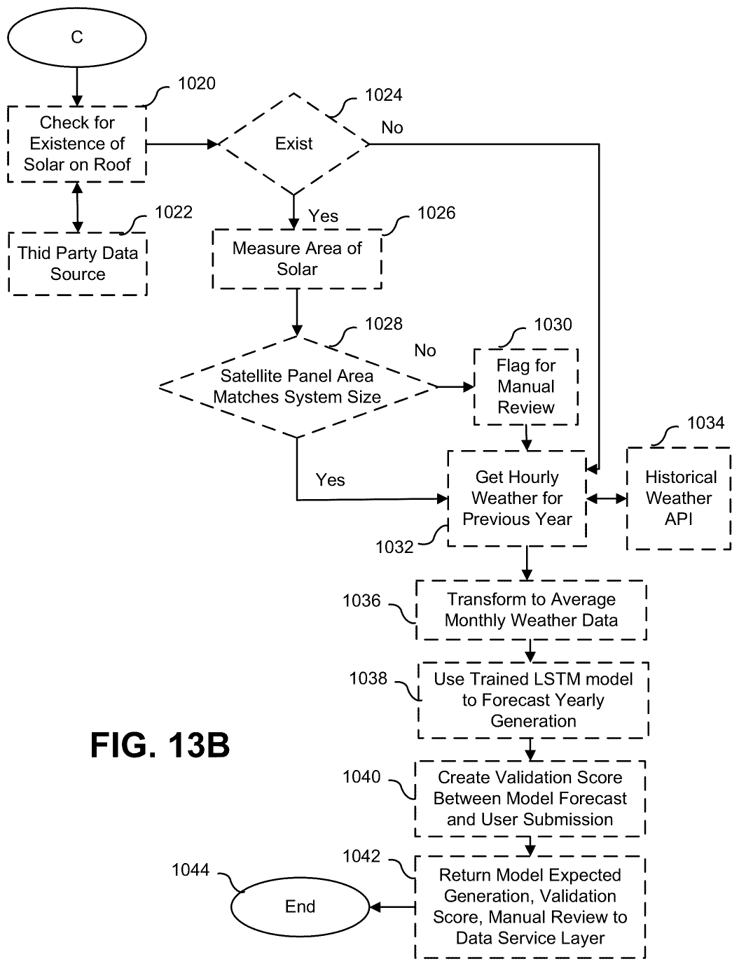

FIG. 13A and FIG. 13B is a flowchart showing a generation validation procedure, according to some embodiments of this disclosure. This method may incorporate satellite imagery analysis, weather data processing, and machine learning techniques to validate submitted solar energy generation data.

FIG. 13A begins at step 1002 and a user may verify (step 1004) the correctness of extracted fields from their uploaded documents. The user can then initiate the validation process by clicking a register/attest button (step 1006). This action may prompt the system to send a POST request to the data module 306 (step 1008) with e.g., file, extracted details, address, whether or not the document contains key features, and/or the like.

The process may then proceed to check (step 1010) if the data contains key features. If the data does not contain key features (“No” branch), the process may move to step 1012 where the system flags the submission for manual review.

If the data does contain key features (“Yes” branch), the process may continue to step 1014 where the system can get the geolocation (e.g., latitude and longitude coordinates) for the address. This may involve an API geocoding process (step 1018) to obtain precise location information geocoding via a call to e.g., a HERE API and can be helpful for subsequent validation processes. At step 1016, the system may send a GET request to retrieve data, such as latitude, longitude, expected generation, system size and the like from the validation service model.

FIG. 13B continues the validation process, illustrating a step 1020, where the system may check for the existence of solar panels on the roof using satellite imagery received e.g., from a third-party data source (step 1022).

Step 1024 may check if satellite imagery of solar panels on the roof exists, and if yes, the system may measure (step 1026) the physical size of the solar system, typically in square meters (m²). This measurement can be used to validate the provided system size against the imagery.

The process may then proceed to step 1028, where the system may determine if the satellite panel area matches the provided system size. If the areas do not match (“No” branch), the process may move to step 1030, where the system can flag the case for manual review. If the areas match (“Yes” branch), the process can advance to step 1032.

At step 1032, the system may obtain hourly weather data for the previous year using the geocoding (e.g., latitude and longitude coordinates). The system may interact (step 1304) with an API connected to the historical weather data (e.g., OpenMeteo™ historical weather API). The obtained hourly weather data may be then transformed into average monthly weather data at step 1036, preparing it for input into the prediction model.

According to various embodiments, step 1038 may involve using a trained LSTM model to forecast yearly generation. This time-series forecasting model can incorporate several features including one or more of:
i. latitude
ii. longitude
iii. wind speed
iv. cloud cover or cloud information
v. temperature
vi. area of solar on roof (derived from satellite imagery or user-given system size, typically in e.g., m²)

At step 1040, the process may create a validation score by comparing the model forecast against the submitted generation data. The system can validate if the given generation and model generation are within a given tolerance (e.g., 10%) with each other.

The process can conclude at steps 1042, and 1044, where the process may return the expected generation, validation score, and/or manual review status to the data module 306. This comprehensive validation process can ensure the accuracy of reported solar energy generation data, flagging discrepancies for further review and maintaining the integrity of the renewable energy incentive program.

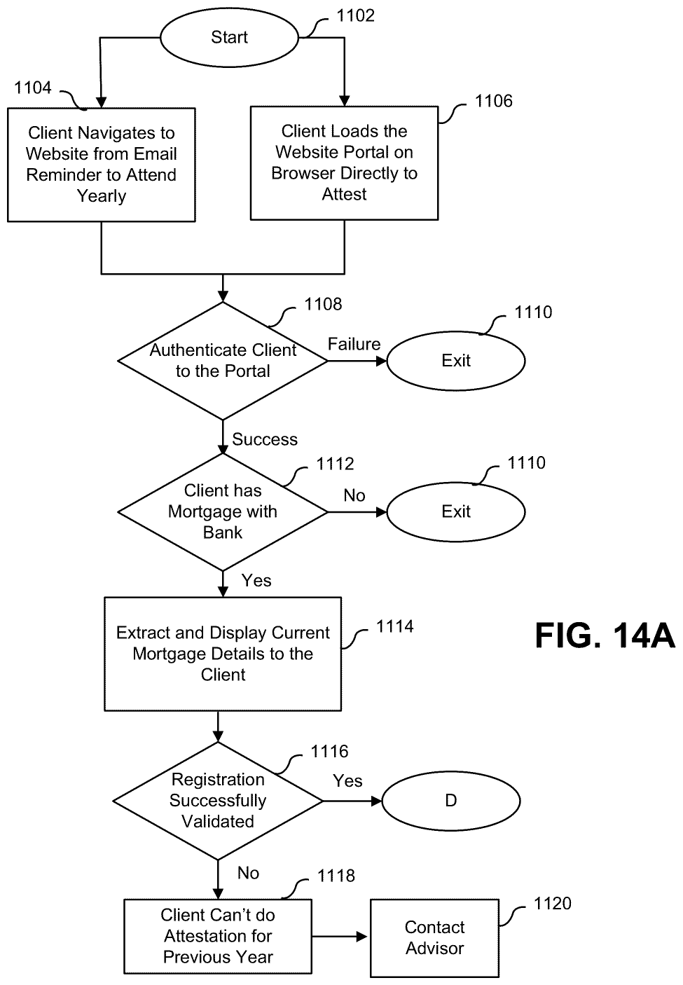

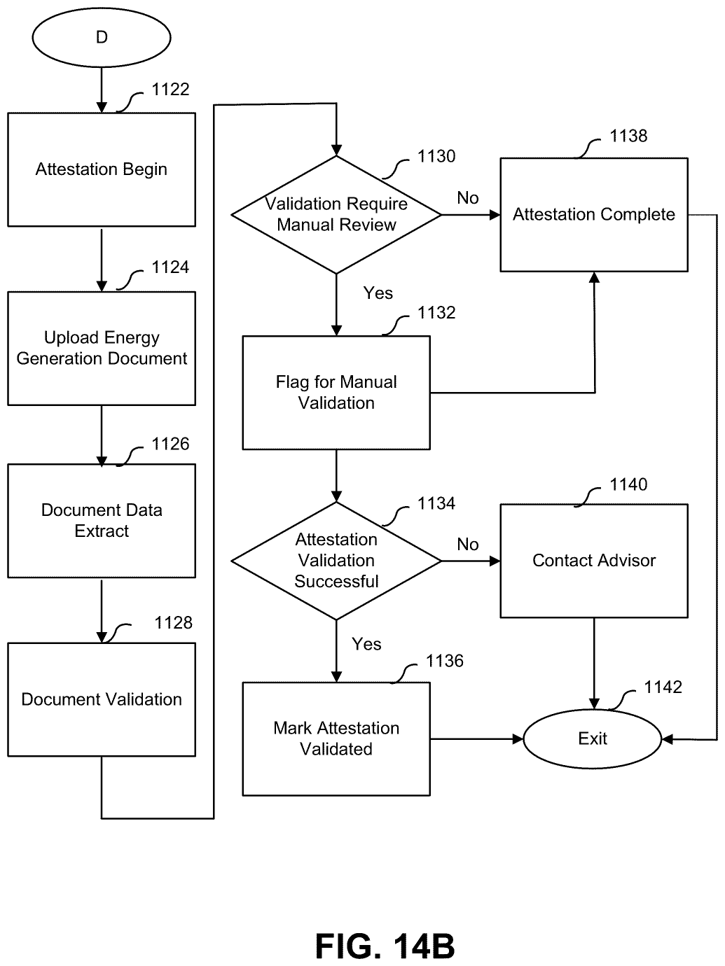

FIG. 14A and FIG. 14B are a flowchart showing an attestation procedure, performed for example, annually. This process can ensure accurate reporting and validation of annual solar energy generation by homeowners.

The process can start (step 1102) with multiple entry points to the attestation process: clients may navigate (step 1104) to the website from an email reminder or load (step 1106) the website portal directly to attest. Both paths can lead to the authentication step 1108, where clients may be authenticated to access the portal.

If authentication fails, the process may follow the path to exit at step 1110. If authentication is successful, the method may proceed to evaluate (step 1112) whether the client has a mortgage with the bank.

If no mortgage exists, the process may move to exit at step 1110. If a mortgage is confirmed, the process may continue to extract and display current mortgage details to the client (step 1114). This step may involve the backend/services module API pulling client information from the data module and allows the client to select the appropriate mortgage for attestation.

The process may then determine (step 1116) if the registration is successfully validated for the selected mortgage property. This step can check that the initial registration for the solar installation is valid and up-to-date. If validation is unsuccessful, it may be determined that the client cannot complete attestation for the previous year (step 1118) and proceeds to prompt the client to contact advisor (step 1120), as the client cannot proceed with attestation without a valid registration.

If validation is successful, the process can initiate (step 1122) the attestation process for the selected mortgage property and proceeds to step 1124 which may prompt the client to upload at least one energy generation document for the selected mortgage property, where the client uploads at least one document containing their annual energy generation data.

Following the document upload, the process can move to document data extract step 1126 and to the document validation step 1128. At the document data extract step 1126, the system can extract relevant information from the uploaded document and validates its type and content, similar to the process as described above. For example, the document data extract step 1126 may include for example, an OCR process to extract the text content from the document, an HDBSCAN process to cluster information based on location; a RAG process to send in most relevant data, and a GEN AI process to locate and pull specific details (e.g., size of the system and expected generation) from the document using prompt engineering. The extracted response can be populated into the respective fields on the attestation form.

From the document validation step 1128, it may be determined whether validation requires manual review, by analyzing for example, whether the actual energy generation is within a given (e.g., 5%) margin of the energy generation based on the initial registration.

If the validation requires manual review (“Yes” branch at step 1130), the process may move to step 1132 to flag for manual validation. If manual review is not required (“No” branch), the process may proceed directly to step 1138 to mark the attestation process complete. At this step, a notification or email may be sent to the client with the attestation details.

After manual validation is flagged at step 1132, the process may determine at step 1134 of whether attestation validation is successful. If the attestation validation is successful (“Yes” branch), the process may move to step 1136 to mark attestation validated. If the attestation validation is not successful (“No” branch), the process may move to step 1140 to prompt the client to contact an advisor.

The process concludes at step 1142, which can be reached either after the attestation is complete, attestation is validated, or after contacting an advisor for unsuccessful validations.

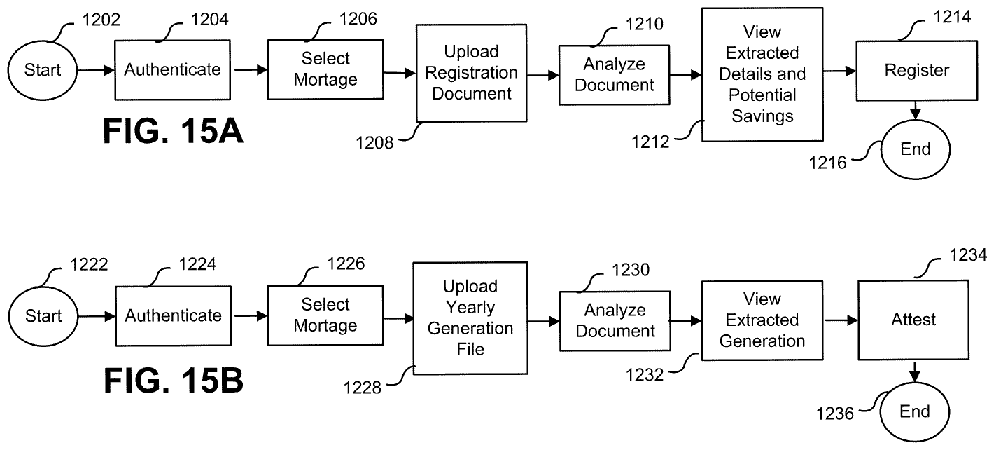

FIG. 15A-15B show examples of the user flow diagrams, according to some embodiments of the disclosure. The flowcharts depict various workflows for registration, and attestation.

FIG. 15A outlines an example user registration flow. The process may begin with user authentication (step 1202 and step 1204), followed by mortgage selection (step 1206) and registration document uploading (step 1208). The process may then move through document analysis (step 1210) as described to extract details and calculate potential savings. This information can be presented (step 1212) to the user before proceeding to the final registration step 1214 and end at step 1216.

FIG. 15B outlines an example user attestation flow. The process may begin with user authentication (step 1222 and step 1224), followed by mortgage selection (step 1226) and yearly generation document uploading (step 12028). The process may then move through document analysis (step 1230) as described to extracts energy generation information. This information can be presented (step 1232) to the user before proceeding to the final attestation step 1234 and end at step 1236.

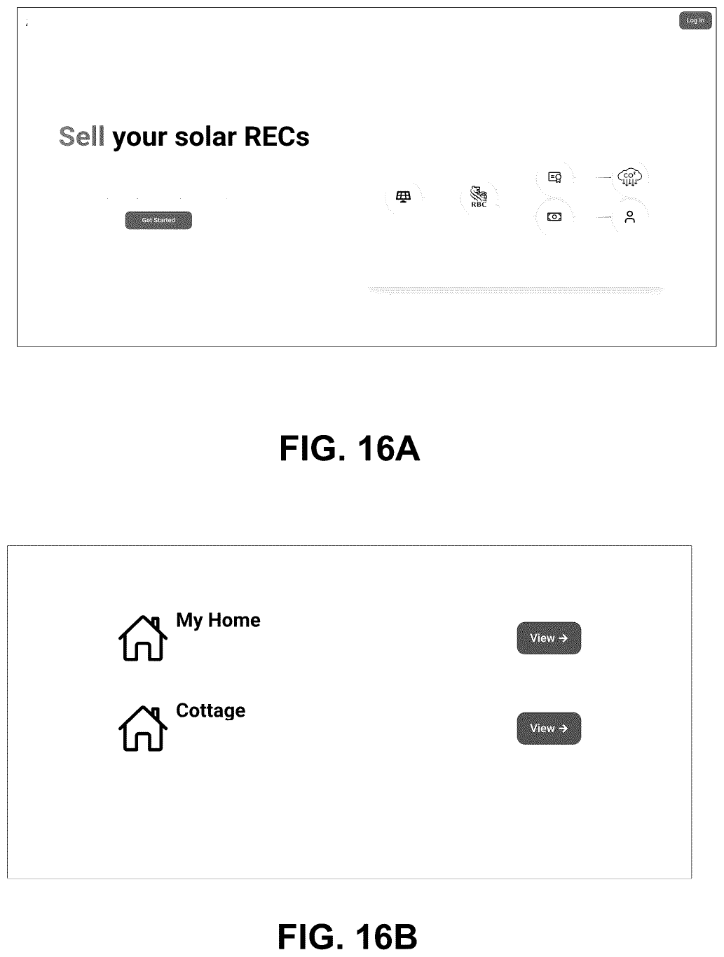

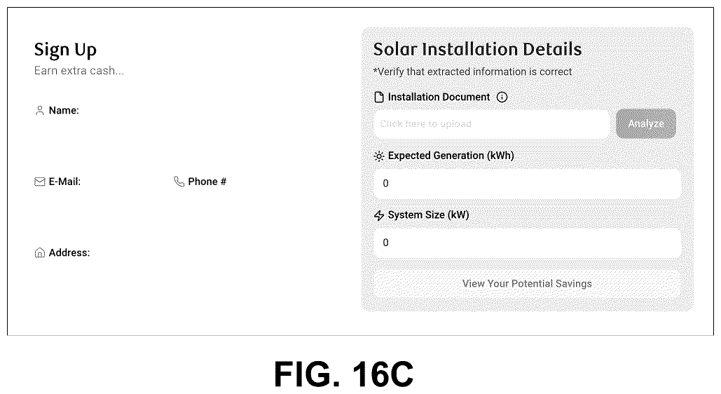

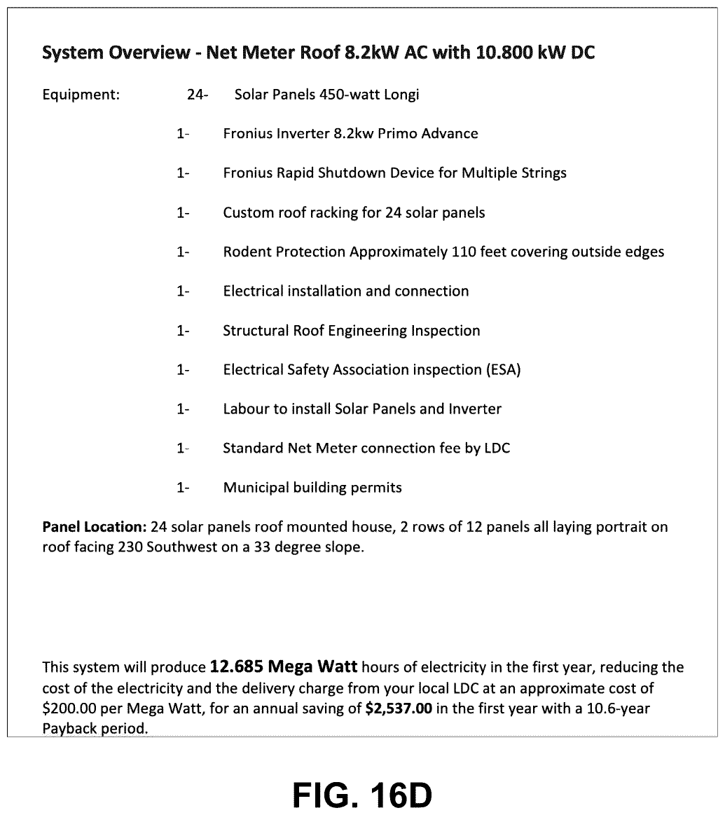

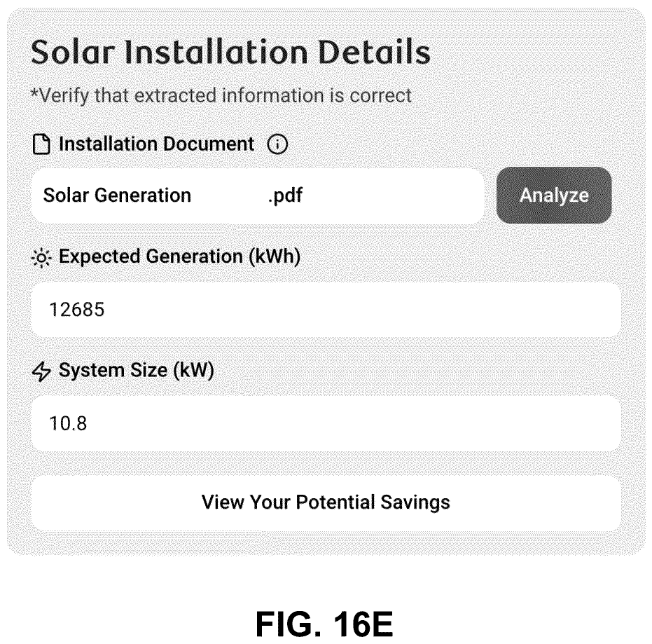

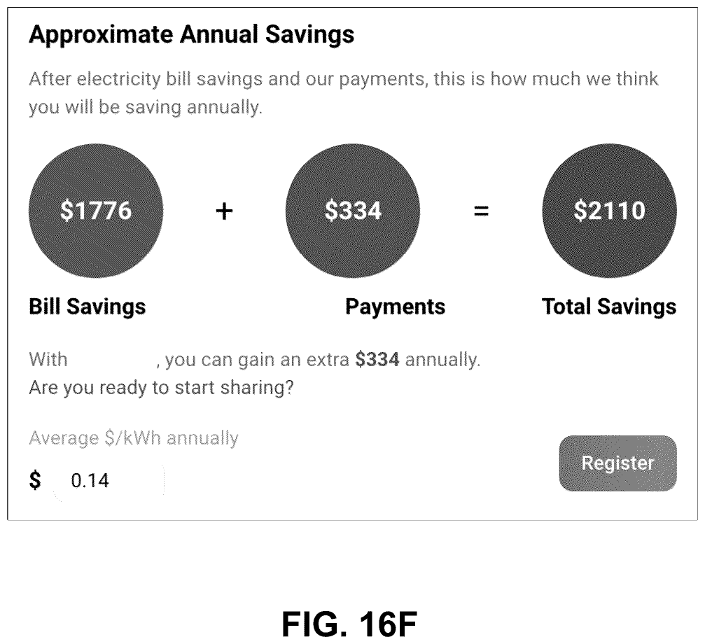

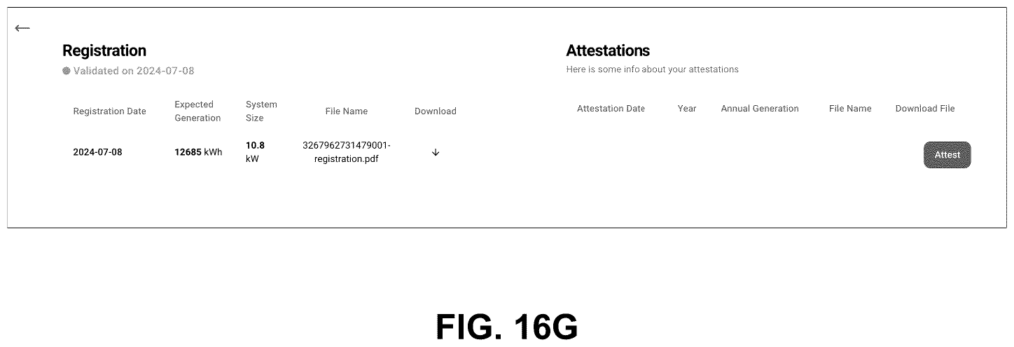

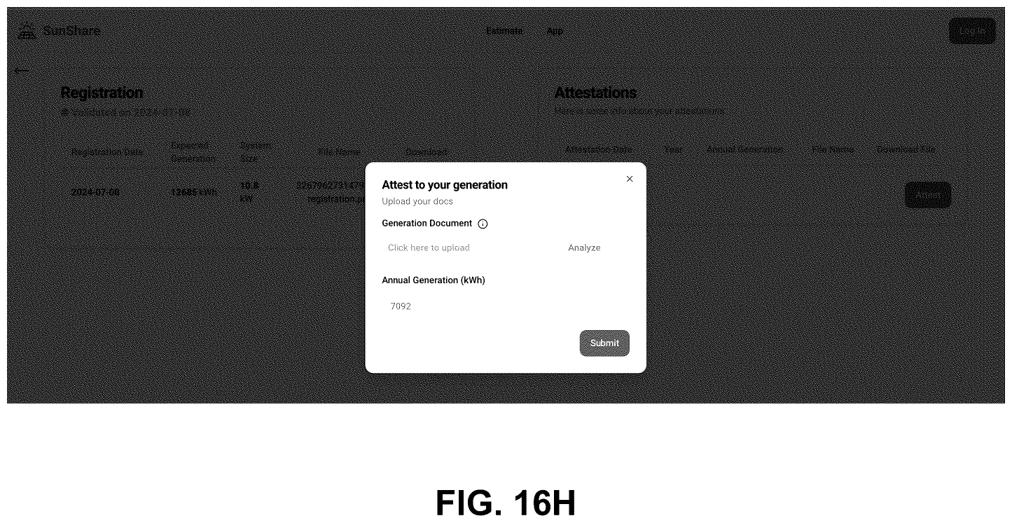

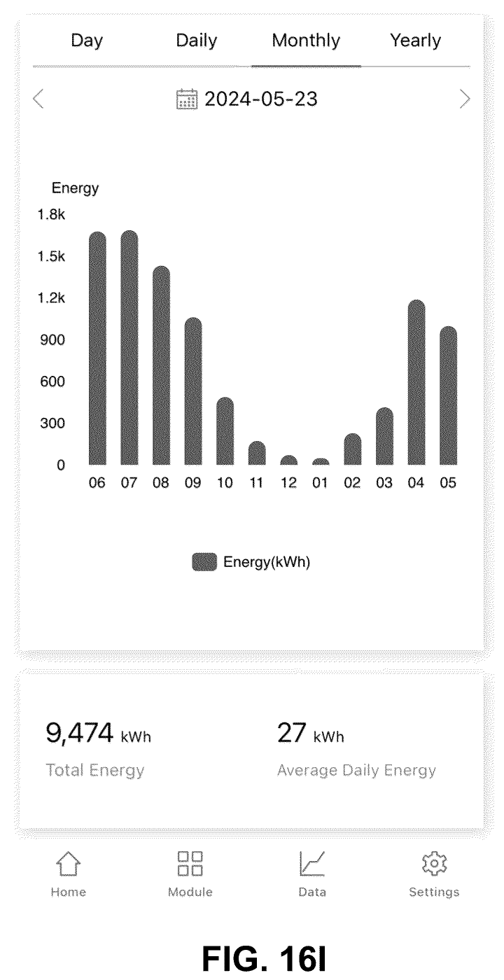

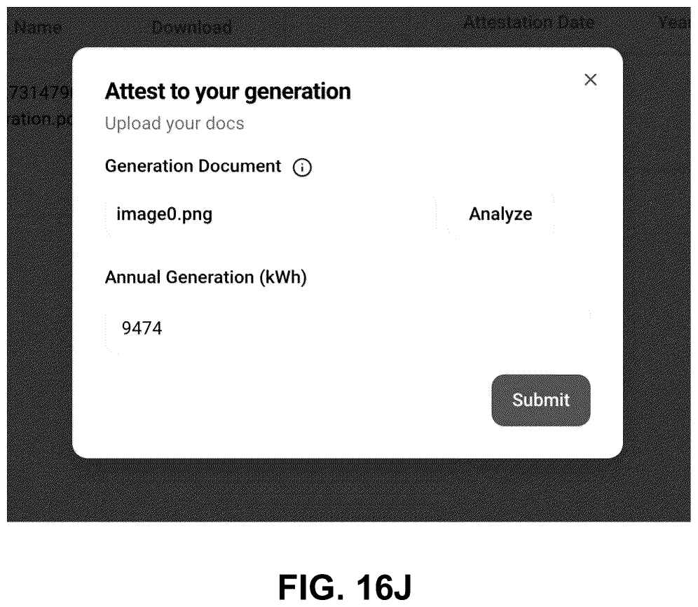

FIGS. 16A to 16L provide examples of the system interfaces for managing homeowner renewable energy incentives, according to some embodiments of the disclosure.

FIG. 16A is an example landing interface for the user of the system, which may provide for example, a registration process involving selecting the mortgage and uploading installation documents; a validation process of using one or more ML models to validate that the generation is in line with prediction, an attestation process involving uploading a screenshot of the generation from the solar application; and a payment process to use the reductions to offset the emissions.

FIG. 16B shows an example interface for the user to select mortgage houses.

FIG. 16C shows an example registration page. As described, the registration page may include pre-prompted user information. The registration page may ask the client to upload installation document which contains expected energy generation and system size. An “Analyze” button is present, allowing users to initiate the document analysis process. The interface may allow users to verify that the extracted information is correct.

FIG. 16D shows an example system overview interface, illustrating the equipment details, panel configuration, expected energy production, and estimated savings.

FIG. 16E shows an example of the solar installation details interface after analysis, showing an expected generation of 12685 kWh and a system size of 10.8 kW. This interface demonstrates how the system can extract and present key information from uploaded documents.

FIG. 16F depicts an example showing approximate annual savings calculations. It visually represents bill savings, payments, and total savings, providing users with a clear understanding of their potential financial benefits.

FIG. 16G shows an example user interface for registration and attestation. As shown in FIG. 16G, the user uploaded registration document has been validated and can upload attestation document.

FIG. 16H shows an example attestation interface. The attestation interface may ask the client to upload attestation document containing annual generation information. An “Analyze” button is present, allowing users to initiate the document analysis process.

FIG. 16I shows an example attestation document, e.g., a screenshot from a vendor application.

FIG. 16J shows an example of the solar power generation attestation after analysis, displaying an annual generation of 9474 kWh, which represents the total power generated over a year.

As described, various embodiments offer a range of differentiated client offerings and features designed to streamline the management of homeowner renewable energy incentives. These features can include client targeting, user authentication, unstructured data extraction, validation processes (such as document type validation and/or expected solar generation validation), registration, and/or estimation of solar power generations. This suite of functionalities can enable efficient handling of various aspects of the renewable energy incentive program.

For clients, the system can provide a user-friendly interface for authentication, registration, and (annual) attestation.

The authentication process can involve a simple username and password login, with an auth token set in headers for secure access.

During registration, clients can select their solar-equipped mortgage and upload an installation document containing system size (or capacity in e.g., kW) and expected generation details or annual production (in e.g., kWh). By the user pressing the “analyze” button initiating the analyzing process, the system can perform document type validation and detail extraction in the background. Clients can view potential savings based on their generation and current rates (e.g., per megawatt-per-hour (MWh)) before completing registration, which includes a validation of expected generation.

The annual attestation process can follow a similar workflow. Clients select their solar mortgage, upload their annual generation document/image including the annual generation (e.g., in kWh). By the user pressing the “analyze” button initiating the analyzing process, the system can perform detail extraction and validation before allowing the client to submit their attestation. The generation can be attested if the attestation is within a given tolerance (e.g., 5%) of the validated registration amount, ensuring accuracy in reporting.

For administrators, the system offers tools for manual review and payment processing. Admins can view registrations and attestations flagged for manual review, examine documents on a dashboard, and mark them as valid or invalid. The payment process may involve downloading validated attestation details in CSV format, processing payments through internal mechanisms, and uploading a CSV of paid client IDs to update the system.

The client targeting functionality is divided into two categories: clients with solar and clients without solar. For existing solar installations, the system can analyze satellite images of rooftops to segment solar panels, calculate total panel area and number of panel counts on the roof, and estimate annual electricity generation. For potential solar installations, the system can assess available rooftop area from one or more batches of images on satellite images of rooftops, isolate individual houses, calculate the dimensions required for a solar system to meet the region's PV potential, and verify if the rooftop has sufficient area for panel placement. This process can return a Boolean result indicating solar panel placement feasibility and provide an estimate of potential annual electricity generation.

These functionalities enable the system 100 to provide a comprehensive solution for managing renewable energy incentives, from identifying potential clients to processing annual payments for existing installations.

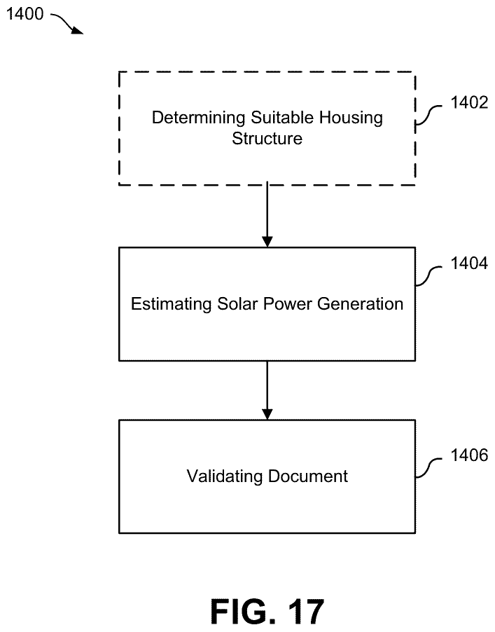

FIG. 17 illustrates a flowchart of a method 1400 for managing solar systems, according to some embodiments of this disclosure. The method 1400 may comprise determining a housing structure suitable for solar system installation based on a plan-view image of the housing structure (step 1402). The method 1400 can estimate solar power generation of the housing structure based on the plan-view image of the housing structure (step 1404), and validate a document related to the solar power generation of the housing structure based on an image of the document and non-text features of the image of the document (step 1406).

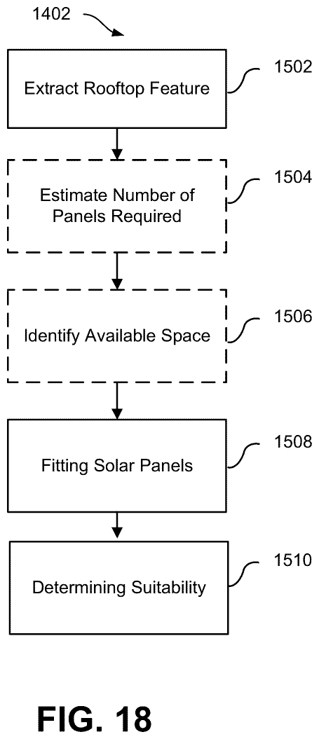

FIG. 18 illustrates a flowchart of a process 1402 of determining housing structure suitability for solar system installation, according to some embodiments of this disclosure. The process 1402 may begin with extracting a roof feature of the housing structure from the plan-view image of the housing structure (step 1502). The process 1402 may further comprise estimating a number of panels required to produce annual electricity close to a potential value (step 1504), and identifying available space on the extracted roof feature (step 1506). A representation of one or more solar panels may be fitted (step 1508) into the extracted roof feature solar panels and it may be determined that the housing structure is suitable for solar system installation if said fitting is successful (step 1510).

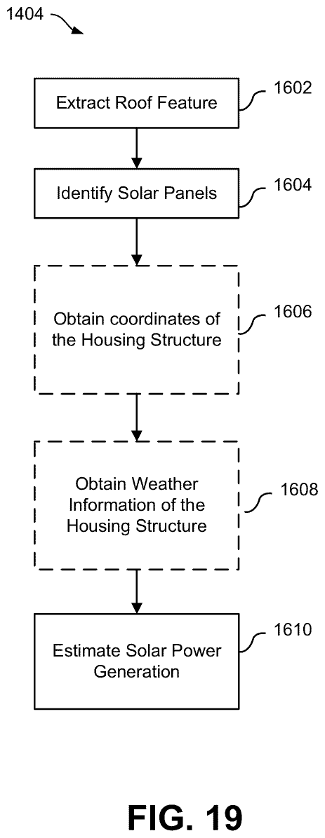

FIG. 19 illustrates a flowchart of a process 1404 of estimating solar power generation, according to some embodiments of this disclosure. The process 1404 may include extracting a roof feature of the housing structure from the plan-view image of the housing structure (step 1602), identifying one or more solar panels from the extracted roof feature (step 1604), and estimating the solar power generation based on the number of identified solar panels and a physical size of each solar panel (step 1606). The process 1404 may further comprise obtaining a latitude and longitude of a location of the housing structure by geocoding an address of the housing structure (step 1608) and obtaining weather information containing for example, at least one of wind speed, cloud information, and temperature pertaining to the location of the housing structure. The solar power generation may be estimated based on the number of identified solar panels, the physical size of each solar panel and the at least one of wind speed, cloud information, and temperature pertaining to the location of the housing structure.

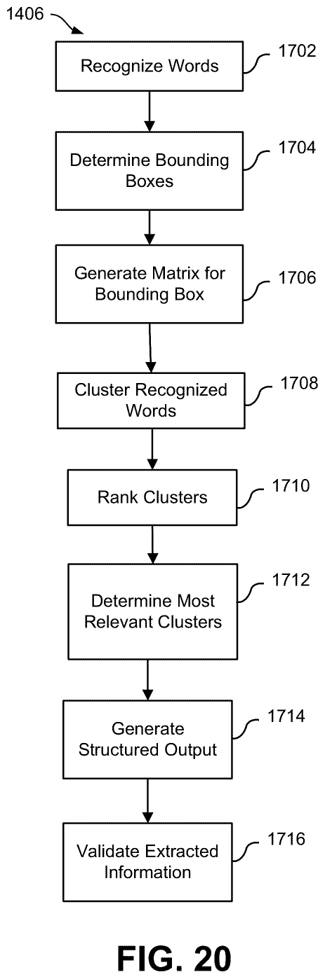

FIG. 20 illustrates a flowchart of a process 1406 of validating a document related to solar power generation, according to some embodiments of this disclosure. The process 1406 may comprise recognizing (step 1702) words from the image of the document; determining (step 1704) a bounding box for each recognized word; generating (step 1706) a matrix for each bounding box, the matrix comprising edge distances between the bounding box and other bounding boxes, and each edge distance being a distance between closest edges of the bounding box and a corresponding one of the other bounding boxes; clustering (step 1708) the recognized words based on the edge distances and sizes of the bounding boxes. The clusters may be ranked (step 1710) based on a prompt; and one or more most relevant clusters may be determined (step 1712) based on said ranking.

Structured output may be output (step 1714) for validation. In some embodiments, the structured output may be in a JSON format, and the structured output may be used to validate (step 1716) the document based on a long short-term memory (LSTM) machine-learning model. In some embodiments, validation of the document can be provided when information extracted from the document aligns with an estimated solar power generation.

The system 100 provides advantageous features and/or functionalities, such as one or more of those described below.

Identifying clients who would benefit from rooftop solar is challenging as there are various factors at play. The described embodiments can combine different datasets and imagery to best predict who would be a good candidate for our product and solar.

Clients can be targeted based on household income, geographic location, age, and/or the like. By utilizing region photovoltaic potential, density-based clustering for demographics data and satellite imagery of rooftops, the system 100 can identify inherent trends in the data to accurately target who would benefit from rooftop solar adoption. This allows the system 100 to streamline the process to target clients by significantly reducing any manual processes needed.

By searching for a suitable arrangement of one or more panels on the roof, the embodiments help speed up and streamline the manual laborious client targeting process.

There exist many solar providers, and many different APIs for the inverters used to capture solar generation. Instead of needing to write different codes to extract data from the many different types of systems, the system 100 provides users with an opportunity to simply upload a document on registration, and a document at the end of every year that tells how much they have generated. This allows scalability for the system and a more generalized solution for development.

Users may upload various types of documents or images that may or may not be acceptable for registering or attesting to generation. The system 100 can validate that user uploaded documents are of a specific type (solar installation, or annual generation). The described system 100 can determine if key features of installation/generation documents exist within the user's uploaded documents. Examples of key features are emissions and financial savings, which exist on most solar installation documents.

Unlike the conventional methods, the described system 100 can use the method that involves one or more of:
1. Use OCR to extract text and bounding boxes on the pages;
2. Create a pair-wise distance matrix between the edges of the text;
3. Cluster the text with HDBSCAN based on at least features of:
   a. Edge distances,
   b. size of bounding boxes (width and height);
4. Rank the clusters against the query using embeddings;
5. Only send the most relevant clusters; and/or
6. Receive structured output.

Those skilled in the art will appreciate that the necessary information tends to exist in groups within the documents, spread out spatially, but not necessarily in paragraphs, such as a PowerPoint™ presentation.

Computer vision has difficulty grouping texts that are of different sizes, and regular chunking with a fixed character limit does not work because chunks may not contain the full context of information required due to the spread-out nature of the documents. Therefore, spatial clustering may be used to reduce the number of tokens.

The system 100 in some embodiments uses HDBSCAN because there is no certain number of clusters required, and clusters can be of different densities. HDBSCAN can also try to filter out noise. In some embodiment, soft clustering may be used to remove that effect, placing the “noisy” text into its most probable cluster.

Conventional HDBSCAN is not used for spatially clustering bounding boxes of text in documents. Rather, it is used to cluster embeddings of text or geospatial coordinates, which may cause an issue in that using the centers of the bounding boxes may lead to bad results due to the varying sizes of text. The system 100 can solve this issue by creating a matrix for each bounding box with the pair-wise distance of the closest edges rather than centers of the boxes, while also accounting for the width and height of the boxes as other features.

This modified HDBSCAN allows the use of RAG techniques to reduce the number of tokens for extracting key features, which can save time, lower costs, and reduce the chance of hallucinations caused by a context window smaller than the document.

Documents can be large and confusing for clients, and processes with many clicks can drive them away from using the energy incentives. The described embodiments can perform many steps in one user click. Within the document validation flow, the system 100 can use the same clustering technique to look for the installation and generation details.

Users may upload valid documents, but they could edit the numbers so that the data may be compromised. The described system 100 can prevent this and flag when they are not being truthful.

The system 100 may perform hyper-parameter tuning to find optimal number of units in the LSTM model architecture, comparing various optimizers and hidden layers.

By using an LSTM model, the system 100 can analyze the temporal relationship in the data, accurately estimating the monthly electricity generation to calculate annual production amount. Other techniques such as Random Forest and Extreme Gradient Boosting may bootstrap the data breaking the temporal relationship leading to trees constructed with large variances despite lower training loss.

As those skilled in the art readily understand, a computer system or a computing device is of limited or even no use if it is not tied to a practical application and/or if it cannot provide sufficient functioning in that practical application. In other words, the usefulness and functioning of a computer system or a computing device needs to be measured in the context of a practical application that the computer system or a computing device is applied therein.

As can be seen from the above description, computer systems have been used in managing solar energy incentives. However, in the practical application of managing solar energy incentives, the functioning of the prior-art computer systems and computers thereof is limited.

With the use of AI engines such as ML engines, the computer systems, computing devices, and computerized methods disclosed herein manage solar energy incentives with improved user experiences. Thus, the computer systems, computing devices, and computerized methods disclosed herein are integrated into a practical application of managing solar energy incentives with improvement to the functioning of the computer systems and computers thereof in this practical application, thereby rendering the computer systems and computing devices thereof more useful in this practical application.

The computer systems, computing devices, and computerized methods disclosed herein represent significantly more than merely providing management functions. In fact, the computer systems, computing devices, and computerized methods disclosed herein provide a practical and technical solution for improving the functioning of the computer network system to better adapt to the solar energy application areas. With the use of AI engines such as ML engines, computing devices are required as essential elements of the system to perform the method disclosed herein.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A computerized method for managing solar systems, the method comprising:
estimating solar power generation of a housing structure based on a plan-view image of the housing structure; and
validating a document related to the solar power generation of the housing structure based on an image of the document and non-text features of the image of the document.

2. The computerized method of claim 1, further comprising determining a housing structure suitable for solar system installation based on the plan-view image of the housing structure.

3. The computerized method of claim 2, wherein said determining the housing structure suitable for solar system installation comprises:
extracting a roof feature of the housing structure from the plan-view image of the housing structure;
fitting a representation of one or more solar panels into the extracted roof feature; and
determining that the housing structure is suitable for solar system installation if said fitting is successful.

4. The computerized method of claim 3, wherein said determining the housing structure suitable for solar system installation further comprises:
estimating a number of panels required to produce annual electricity close to a potential value; and
identifying available space on the extracted roof feature.

5. The computerized method of claim 1, wherein said estimating the solar power generation of the housing structure comprises:
extracting a roof feature of the housing structure from the plan-view image of the housing structure;
identifying one or more solar panels from the extracted roof feature; and
estimating the solar power generation based on the number of identified solar panels and a physical size of each solar panel.

6. The computerized method of claim 5, wherein said estimating the solar power generation of the housing structure further comprises:
obtaining a latitude and longitude of a location of the housing structure by geocoding an address of the housing structure;
obtaining at least one of wind speed, cloud information, and temperature pertaining to the location of the housing structure; and
estimating the solar power generation based on the number of identified solar panels, the physical size of each solar panel and the at least one of wind speed, cloud information, and temperature pertaining to the location of the housing structure.

7. The computerized method of claim 1, wherein said validating a document related to the solar power generation of the housing structure comprises:
validating that information extracted from the document aligns with the estimated solar power generation.

8. The computerized method of claim 1, wherein said validating the document related to the solar power generation of the housing structure comprises:
recognizing words from the image of the document;
determining a bounding box for each recognized word;
generating a matrix for each bounding box, the matrix comprising edge distances between the bounding box and other bounding boxes, and each edge distance being a distance between closest edges of the bounding box and a corresponding one of the other bounding boxes;
clustering the recognized words based on the edge distances and sizes of the bounding boxes;
ranking the clusters based on a prompt;
determining one or more most relevant clusters based on said ranking; and
generating structured output for validation.

9. The computerized method of claim 8, wherein the structured output is in a JavaScript™ Object Notation (JSON) format.

10. The computerized method of claim 8 further comprising:
using the structured output to validate the document based on a long short-term memory (LSTM) machine-learning model.

11. A system comprising:
one or more processors; and
one or more non-transitory computer-readable storage media functionally coupled to the one or more processors;
wherein the or more non-transitory computer-readable storage media comprise computer-executable instructions; and
wherein the instructions, when executed, cause the one or more processors to perform the method comprising:
estimating solar power generation of a housing structure based on a plan-view image of the housing structure; and
validating a document related to the solar power generation of the housing structure based on an image of the document and non-text features of the image of the document.

12. The system of claim 11, wherein the method further comprises determining a housing structure suitable for solar system installation based on the plan-view image of the housing structure.

13. The system of claim 12, wherein said determining the housing structure suitable for solar system installation comprises:
extracting a roof feature of the housing structure from the plan-view image of the housing structure;
fitting a representation of one or more solar panels into the extracted roof feature; and
determining that the housing structure is suitable for solar system installation if said fitting is successful.

14. The system of claim 13, wherein said determining the housing structure suitable for solar system installation further comprises:
estimating a number of panels required to produce annual electricity close to a potential value; and
identifying available space on the extracted roof feature.

15. The system of claim 11, wherein said estimating the solar power generation of the housing structure comprises:
extracting a roof feature of the housing structure from the plan-view image of the housing structure;
identifying one or more solar panels from the extracted roof feature; and
estimating the solar power generation based on the number of identified solar panels and a physical size of each solar panel.

16. The system of claim 15, wherein said estimating the solar power generation of the housing structure further comprises:
obtaining a latitude and longitude of a location of the housing structure by geocoding an address of the housing structure;
obtaining at least one of wind speed, cloud information, and temperature pertaining to the location of the housing structure; and
forecasting the solar power generation based on the number of identified solar panels, the physical size of each solar panel and the at least one of wind speed, cloud information, and temperature pertaining to the location of the housing structure.

17. The system of claim 11, wherein said validating a document related to the solar power generation of the housing structure comprises:
validating that information extracted from the document aligns with the estimated solar power generation.

18. The system of claim 11, wherein said validating the document related to the solar power generation of the housing structure comprises:
recognizing words from the image of the document;
determining a bounding box for each recognized word;
generating a matrix for each bounding box, the matrix comprising edge distances between the bounding box and other bounding boxes, and each edge distance being a distance between closest edges of the bounding box and a corresponding one of the other bounding boxes;
clustering the recognized words based on the edge distances and sizes of the bounding boxes;
ranking the clusters based on a prompt;
determining one or more most relevant clusters based on said ranking; and
generating structured output for validation.

19. The system of claim 18, wherein the method further comprises:
using the structured output to validate the document based on a long short-term memory (LSTM) machine-learning model.

20. One or more non-transitory computer-readable storage media comprising computer-executable instructions, wherein the instructions, when executed, cause one or more processors to perform the method comprising:
estimating solar power generation of a housing structure based on a plan-view image of the housing structure; and
validating a document related to the solar power generation of the housing structure based on an image of the document and non-text features of the image of the document.
